(19) United States
(12) Patent Application Publication
(10) Pub. No.: US 2025/0330367 A1
(43) Pub. Date: Oct. 23, 2025

(54) SYSTEM AND METHOD FOR GENERATING A MULTI-COMPONENT SIGNAL INCLUDING A MODULATED SIGNAL AND AN AUXILIARY SIGNAL

(71) Applicant: TeraWave, Inc., Naples, FL (US)

(72) Inventors: Torsten SCHULTZE, Naples, FL (US); Ulrich ALTVATER, Naples, FL (US)

(21) Appl. No.: 19/181,114

(22) Filed: Apr. 16, 2025

Related U.S. Application Data
(60) Provisional application No. 63/636,581, filed on Apr. 19, 2024.
(60) Provisional application No. 63/645,734, filed on May 10, 2024.

(51) Int. Cl. H04L 27/34

(52) U.S. Cl. CPC H04L 27/34

(57) ABSTRACT

A system and method for generating a multi-component signal including a modulated signal and an auxiliary signal by embedding the auxiliary signal within the modulated signal. The method includes receiving input digital data and generating, based upon the input digital data, zero-crossing modulated waveform data encoding the input digital data. The zero-crossing modulated waveform data represents an auxiliary zero-crossing modulated waveform having a plurality of periods wherein portions of the plurality of periods are shifted in phase relative to a sinusoid. The method further includes mixing the zero-crossing modulated waveform data and modulation data representing a modulated signal wherein the mixing produces a multi-component signal. The modulated signal may consist of a frequency modulated signal, an amplitude modulated signal, or other conventionally modulated signal.

### CROSS-REFERENCE TO RELATED APPLICATIONS

This application claims the benefit of priority under 35 U.S.C. § 119(e) of U.S. Provisional Patent Application No. 63/636,581, entitled EMBEDDING OF MESSAGE WAVEFORMS WITHIN UNCONCEALED WIRELESS SIGNAL TRANSMISSIONS, filed on Apr. 19, 2024, and of U.S. Provisional Patent Application No. 63/645,734, entitled SYSTEM AND METHOD FOR EMBEDDING MESSAGE WAVEFORMS WITHIN CONVENTIONALLY MODULATED SIGNALS, filed on May 10, 2024, the content of each of which is incorporated herein by reference in its entirety for all purposes. This application is related to U.S. Application Ser. No. ______ (Attorney Docket No. WAVE-009/01US), entitled METHOD FOR EMBEDDING MESSAGE WAVEFORMS WITHIN CONVENTIONALLY MODULATED SIGNALS, filed on even date herewith, to U.S. Application Ser. No. ______ (Attorney Docket No. WAVE-019/00US), entitled SYSTEM

FOR EMBEDDING MESSAGE WAVEFORMS WITHIN CONVENTIONALLY MODULATED SIGNALS, filed on even date herewith, to U.S. Application Ser. No. ______ (Attorney Docket No. WAVE-017/00US), entitled SYSTEM AND METHOD FOR GENERATING A COMPOSITE SIGNAL INCLUDING AN AUXILIARY SIGNAL INTERPOSED BETWEEN PERIODS OF A MODULATED SIGNAL, and to U.S. Application Ser. No. (Attorney Docket No. WAVE-018/00US), entitled SYSTEM AND METHOD FOR GENERATING A COMPOSITE SIGNAL BY REPLACING MODULATED SIGNAL SEGMENTS WITH AUXILIARY SIGNALS, filed on even date herewith, the content of each of which is incorporated herein by reference in its entirety for all purposes.

### FIELD

The present disclosure pertains generally to data communication systems and, in particular, to methods and systems for data signal concealment.

### BACKGROUND

Traditional modulation techniques, such as amplitude modulation (AM) and frequency modulation (FM), suffer from inherent inefficiencies that limit their capacity for high-speed data transmission. More advanced modulation techniques, such as quadrature amplitude modulation (QAM) and quadrature phase shift keying (QPSK), have been developed to improve data transmission rates. However, even these techniques have limitations in terms of the amount of information that can be transmitted over a given bandwidth.

One of the main inefficiencies associated with QAM and QPSK modulation is their limited spectral efficiency. Spectral efficiency refers to the amount of information that can be transmitted over a given bandwidth. QAM and QPSK modulation techniques are not able to efficiently use the available bandwidth, as they require a large amount of spectral resources to achieve high data rates. This limits their capacity to transmit large amounts of data over long distances.

The demand for high-speed data transmission has increased significantly in recent years, driven in part by the proliferation of applications requiring substantial bandwidth, such as audio and video streaming, sharing of photos and videos, and more. This trend has increased the strain on existing wireless and other telecommunications systems, which are struggling to keep up with the growing demand for bandwidth, and has created a need to utilize the available spectrum more efficiently.

Various techniques have been proposed in an attempt to reduce the spectral bandwidth required for transmission without significantly degrading the quality of the transmitted signals. These techniques include bandwidth compression and signal shaping.

Bandwidth compression techniques typically involve reducing the occupied bandwidth of a modulated signal by selectively filtering out unwanted frequencies. These techniques can be effective, but they often result in signal distortion and loss of information.

Signal shaping techniques involve modifying the waveform of the modulated signal to reduce its spectral bandwidth while maintaining its original shape and quality. These techniques can be helpful in reducing required bandwidth, but they can be complex and computationally intensive.

### SUMMARY

Disclosed herein is a method and apparatus for generation of a multi-component signal including a modulated signal and an auxiliary zero-crossing modulated waveform. The modulated signal may be a frequency modulated (FM) signal or an amplitude modulated (AM) signal. The method includes receiving input digital data and generating, based upon the input digital data, zero-crossing modulated waveform data. The zero-crossing modulated waveform data encodes the input digital data and represents an auxiliary zero-crossing modulated waveform having a plurality of periods wherein portions of the plurality of periods are perturbed in at least one of amplitude and phase relative to a sinusoid. The method further includes mixing the zero-crossing modulated waveform data and FM data representing the FM signal wherein the mixing produces the multi-component signal. Alternatively, AM data representing the AM signal, or data representing another conventionally modulated signal, may be utilized in producing the multi-component signal.

The disclosure also relates to a method and apparatus for generation of a composite signal including a modulated signal and an auxiliary waveform embedded within the modulated signal. The method involves receiving input digital data and utilizing it to produce the auxiliary waveform, which in one embodiment may be a zero-crossing-modulated waveform. The method also includes generating a modulation timing signal and creating a modulation signal which may have a frequency determined by the modulation timing signal. A composite signal is generated using the modulated signal and a zero-crossing modulated waveform. In one embodiment periods of the zero-crossing-modulated waveform are strategically placed between periods of the modulated signal within the composite signal.

The modulated signal may be a conventionally modulated signal, such as an amplitude modulated signal or a frequency modulated signal. In exemplary implementations the composite signal appears substantially indistinguishable from the modulated signal in the frequency domain. As a consequence, the zero-crossing modulated waveform may be embedded within the composite signal. A receiver may be configured to remove the modulated signal from the composite signal and to then decode the remaining received auxiliary zero-crossing modulated waveform. In this way the input digital data used to generate the zero-crossing modulated waveform may be covertly conveyed from a transmitter to a receiver.

Although only a single period of the auxiliary zero-crossing modulated-waveform may be interposed between sets of periods of the modulated signal, in some cases multiple or repeated periods of the zero-crossing-modulated waveform may be placed within the composite signal. These multiple periods of the zero-crossing-modulated waveform may be preceded and followed by multiple periods of the modulated signal.

The disclosed apparatus may include a modulated timing signal generator and a composite signal generator. The composite signal generator incorporates a zero-crossing modulator to produce the zero-crossing-modulated waveform, strategically interspersed with periods of the modulated signal. The apparatus may further include a digital-to-analog converter for outputting an analog signal based on the composite signal.

This disclosure also describes methods which involve receiving a composite signal comprising a modulated signal and a zero-crossing-modulated waveform, where periods of the composite signal contain the zero-crossing-modulated waveform interposed between periods of the modulated signal. The received composite signal may be mixed with a modulated local oscillator signal, resulting in the generation of a reconstructed zero-crossing modulated waveform. To enhance the accuracy of the reconstruction, a correction signal is generated based on the characteristics of the reconstructed waveform. The frequency of the local oscillator signal is then adjusted using this correction signal, ensuring precise alignment.

The disclosed receiving method also includes phase-locking the received signal and the local oscillator signal for improved synchronization. The detection of phase shifts within periods of the reconstructed waveform allows for the generation of correction data, which is further converted into a correction signal through a digital-to-analog converter.

The reconstructed zero-crossing modulated waveform is analyzed, revealing in-phase (I) and quadrature phase (Q) reconstructed components. These components can be converted into digital forms, facilitating further processing.

The frequency adjustment of the local oscillator may involve modulating a reference signal based on the correction signal, contributing to the accuracy of the demodulation process. The demodulation of the reconstructed waveform may include the detection of zero crossings, where each period's polarity change is analyzed to recover payload data effectively.

In one particular aspect the disclosure pertains to a method which includes receiving input digital data and producing, using the input digital data, a stream of waveform data defining a zero-crossing-modulated waveform. The method further includes generating a modulating timing signal by using a low data rate signal to modulate a reference signal. A composite signal is also generated where the composite signal includes a modulated signal having a frequency determined by the modulation timing signal. The process of generating the composite signal further includes inserting periods of the zero-crossing-modulated waveform into the composite signal so that one or more periods of the zero-crossing-modulated waveform are interposed between periods of the modulated signal.

In one implementation each period of the zero-crossing-modulated waveform within the composite signal is preceded and followed by multiple periods of the modulated signal. In other implementations each period of the zero-crossing-modulated waveform is sequentially replicated as multiple sequential periods of the composite signal. The multiple sequential periods of the composite signal are preceded by a plurality of periods of the composite signal corresponding to a plurality of periods of the modulated signal.

The zero-crossing-modulated waveform is of a first frequency, the modulation signal is frequency modulated about a second frequency typically different from the first frequency, and the composite signal is frequency modulated about a third frequency different from the first frequency and the second frequency.

The disclosure is also particularly directed to an apparatus including a modulated timing signal generator configured to generate a modulated timing signal. The apparatus further includes a composite signal generator operative to generate a composite signal where the composite signal includes a modulated signal having a frequency determined by the modulation timing signal. The composite signal generator includes a zero-crossing modulator configured to produce a stream of waveform data defining a zero-crossing-modulated waveform. One or more periods of the zero-crossing modulated waveform are interposed between periods of the modulated signal in the composite signal.

The disclosure further relates to a method which includes receiving a received composite signal including a modulated signal and a zero-crossing-modulated waveform. Periods of the received composite signal comprise periods of the zero-crossing-modulated waveform interposed between periods of the modulated signal. The method further includes mixing the received composite signal with a modulated local oscillator signal to produce a reconstructed zero-crossing modulated waveform. A correction signal is generated based upon the reconstructed zero-crossing modulated waveform and a frequency of the local oscillator signal is adjusted based upon the correction signal. The reconstructed zero-crossing modulated waveform is demodulated to recover payload data carried by the received signal.

The method may further include phase-locking the received signal and the local oscillator signal. In one implementation this may include detecting phase shifts within periods of the reconstructed zero-crossing modulated waveform, generating correction data based upon the phase shifts, and converting the correction data into the correction signal using a digital-to-analog converter.

The adjusting the frequency of the local oscillator may include modulating a frequency of a reference signal based on the correction signal. In addition, the demodulating the reconstructed zero-crossing modulated waveform may include detecting zero crossings of the reconstructed zero-crossing modulated waveform.

These and other advantages of the present disclosure will become apparent after considering the following detailed specification in conjunction with the accompanying drawings.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. Also, common but well-understood elements that are useful or necessary in a commercially feasible embodiment are often not depicted in order to facilitate a less obstructed view of these various embodiments of the present invention. In the drawings, like reference characters generally refer to like features (e.g., functionally similar and/or structurally similar elements).

FIG. 1 is a block diagram of a communications system having a transmitter and a receiver constructed in accordance with the present disclosure.

FIG. 2 is a block diagram of an embodiment of the transmitter shown in FIG. 1.

FIG. 3 is a block diagram of an embodiment of the receiver shown in FIG. 1.

FIG. 4 which illustrates a set of zero-crossing modulated quasi-sinusoidal waveforms in accordance with the disclosure.

FIG. 5 illustrates an alternate set of zero-crossing modulated quasi-sinusoidal waveforms in accordance with an embodiment.

FIG. 6 is a functional block diagram of an embodiment of a transmitter configured to generate and transmit zero-crossing-phase-modulated quasi-sinusoidal waveforms.

FIG. 7 is a functional block diagram of a receiver configured to receive and demodulate zero-crossing-phase-modulated quasi-sinusoidal waveforms.

FIG. 8 illustrates a zero-crossing-phase-modulated quasi-sinusoidal waveform in the form of the shape-shifted sinusoidal waveform encoded using a continuous piecewise function.

FIG. 9 illustrates a zero-crossing-phase-modulated quasi-sinusoidal waveform in the form of the shape-shifted sinusoidal waveform alternately encoded using a continuous function.

FIG. 10 is a functional block diagram of an embodiment of a transmitter configured to generate and transmit zero-crossing-phase-modulated quasi-sinusoidal waveforms in the form of the shape-shifted sinusoidal waveforms illustrated in FIGS. 8 and 9.

FIG. 11 is a functional block diagram provided of a receiver configured to receive and demodulate zero-crossing-phase-modulated quasi-sinusoidal waveforms in the form of shape-shifted sinusoidal continuous piecewise waveforms.

FIGS. 12A and 12B illustrate zero-crossing-phase-modulated quasi-sinusoidal waveforms in the form of shape-shifted sinusoidal continuous piecewise waveforms.

FIG. 13 is an exemplary process for decoding information within zero-crossing-phase-modulated quasi-sinusoidal waveforms in the form of shape-shifted sinusoidal continuous piecewise waveforms.

FIG. 14 is an embodiment of a communication system configured to embed message waveforms within unconcealed wireless signal transmissions.

FIG. 15 provides a detailed representation of a transmitter unit corresponding to a particular embodiment of the transmitter unit of FIG. 14.

FIG. 16 illustrates multiple periods of an exemplary analog composite signal generated in accordance with the disclosure.

FIG. 17 which provides a detailed representation of a receiver unit corresponding to particular embodiment of the receiver unit of FIG. 14.

FIG. 18 is a block diagram representative of a transmitter configured to embed message waveforms within conventionally modulated communication signals in accordance with an embodiment.

FIG. 19 provides a detailed representation of a transmitter unit corresponding to a particular embodiment of the transmitter unit of FIG. 14.

FIG. 20A is a block diagram representative of a receiver configured to recover message waveforms embedded within carrier signals of communication signals in accordance with an embodiment.

FIG. 20B depicts a constellation diagram corresponding to 8 phase-shift keying (8 PSK) modulation.

FIG. 21 is a block diagram representative of a transmitter configured to transmit auxiliary message waveforms with a frequency modulated communication signal in accordance with an embodiment.

FIG. 22 is a block diagram representative of a receiver configured to receive and process a multi-component analog signal in accordance with the disclosure.

FIG. 23 is a block diagram representative of a transmitter configured to transmit auxiliary message waveforms and optionally colored noise with a frequency modulated communication signal in accordance with an embodiment.

### DETAILED DESCRIPTION

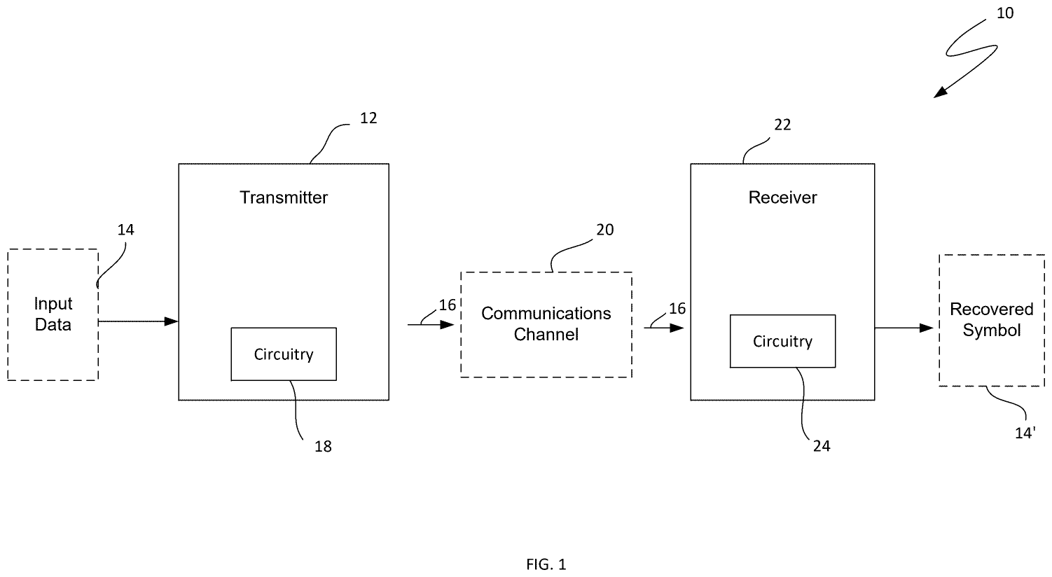

Referring now to the drawings, wherein like numbers refer to like items, number 10 identifies an exemplary communications system. With reference now to FIG. 1, the data transmission or communications system 10 is shown to comprise a transmitter 12 for receiving input data 14 and for generating an encoded waveform 16 comprised of a zero-crossing modulated waveform representative of the input data 14. As is discussed below, in one embodiment the encoded waveform 16 is very nearly, but not exactly, sinusoidal in that the zero crossing of the waveform varies between periods (e.g., within +/−9 degrees of 180 degrees) in accordance with the input data 14. Moreover, in certain embodiments each period of the encoded waveform 16 will generally be of approximately the same duration T, but not necessarily of identical duration. However, in such embodiments the duration of the average period of the encoded waveform 16 over a suitably large number of cycles will be substantially equivalent or identical to T.

In the embodiment of FIG. 1, each period of the encoded waveform 16 includes one cycle of a zero-crossing modulated waveform representative of one bit of the input data 14. Circuitry 18 transmits the encoded waveform 16 over a communications channel 20. The system 10 also comprises a receiver 22 for receiving the encoded waveform 16, and circuitry 24 for recovering a replica of the input data 14 from the encoded waveform. The receiver 22 may output the recovered input data 14 to some other device, such as, by way of example only, a monitor, a computer, an audio component, or a speaker. The communications channel 20 may be provided by media such as coaxial cable, fiber optic cable, telephone or telephone company (telco) lines such as copper wires, open air as by radio frequency or space or satellite. The channel 20 may carry one or many messages.

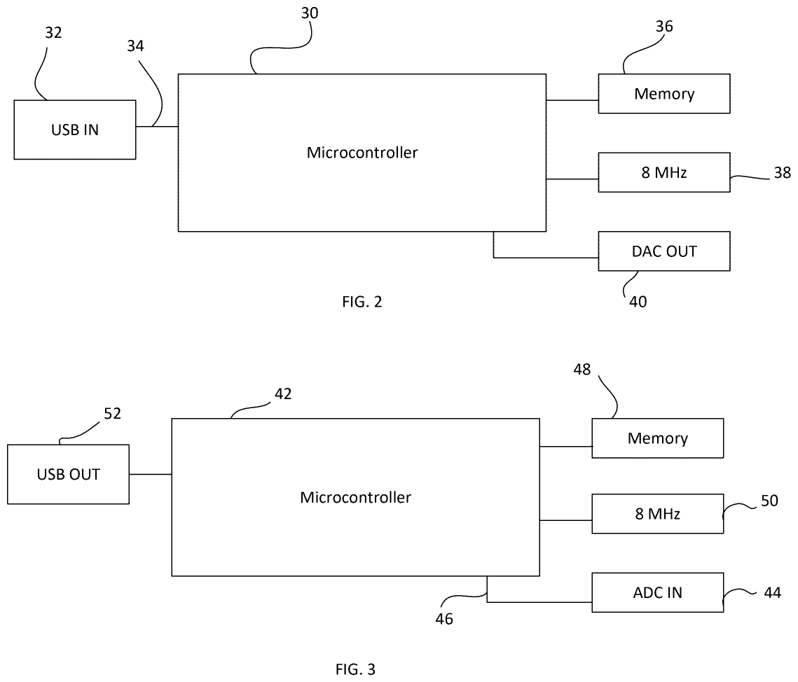

With reference now to FIG. 2, a block diagram of the transmitter 12 is depicted. The transmitter 12 has a microcontroller 30 that has a USB input 32 for receiving the input data 14, which may represent, for example, music, video, text, or a combination thereof. The input data 14 is provided from the USB input 32 to the microcontroller 30 over a connection 34. The microcontroller 30 may also include memory 36, such as a 16 MB memory, an 8 MHz input 38, and a digital-to-analog converter (DAC) output 40. The microcontroller 30 can read in the input data 14, disassemble the input data 14, and modulate the zero crossings of individual waveform periods to generate the encoded waveform 16 representative of the input data 14. The zero crossings of the individual waveform cycles may be modulated so as to vary from 180 degrees by, for example, +/-9 degrees. In other embodiments the zero crossings of the waveform cycles may also slightly deviate from 0 and 360 degrees, but generally not by more than 1 or 2 degrees. In still other embodiments the individual waveform cycles of the encoded waveform may be subtly perturbed in at least one of amplitude and phase without materially affecting the zero crossings of the encoded waveform 16.

The microcontroller 30 provides the encoded waveform 16 to the DAC output 40. The DAC output 40 may be connected to other circuitry (not shown) that can transmit the encoded waveform 16. In one embodiment the microcontroller 30 is comprised of an Intel Core i9 processor configured with GNURadio software (https://github.com/gnuradio) in combination with a bladeRF SDR board (https://www.nuand.com/bladerf-2-0-micro/).

FIG. 3 shows a block diagram of an embodiment of the receiver 22 constructed to process zero-crossing-encoded quasi-sinusoids. The receiver 22 comprises a microcontroller 42 that has an analog to digital converter (ADC) input 44 for receiving the encoded signal 16 comprised of a zero-crossing modulated waveform transmitted by the transmitter 12. The signal 16 from the input 44 is provided to the microcontroller 30 over a connection 46. The microcontroller 42 may also include memory 48, such as a 16 MB memory, an 8 MHz input 50, and an RS232 or USB output 52. The output 52 is provided to another device (not shown), such as a speaker. The microcontroller 42 also reads in the signal 16 from the ADC input 44, reassembles the input data 14, and sends the symbol to the output 52 for use by the other device (not shown). Again, an example of the microcontroller 30 is a device manufactured by STMicroelectronics known as STM32F756 family of microcontrollers or another similar microcontroller may be used.

As is discussed below, each period of the encoded waveform 16 includes a zero-crossing modulated waveform cycle having a zero crossing proximate 180 degrees that is dependent upon the value of the bit of the input data 14 represented by such period of the encoded waveform 16. Thus, the zero crossing within a given period of the encoded waveform 16 is encoded in order to reflect the bit value of the input data associated with such period, and in one embodiment each such zero-crossing-encoded quasi-sinusoid is of identical duration. As a consequence, the frequency of the encoded waveform 16 is constant and each zero-crossing modulated waveform cycle crosses zero at the beginning and end of a period of the encoded waveform 16 and completely defines a bit value of input digital data. In other embodiments the zero crossings at the beginning and the end of each such zero-crossing modulated waveform cycle do not define periods of identical duration and thus the frequency of the encoded waveform 16 may slightly vary between periods (e.g., the frequency between periods may vary by 1% or less). Nonetheless, in both of these embodiments it has been observed that nearly all of the signal energy of encoded waveforms 16 is concentrated within a very narrow bandwidth about the single or average frequency of the encoded waveform 16.

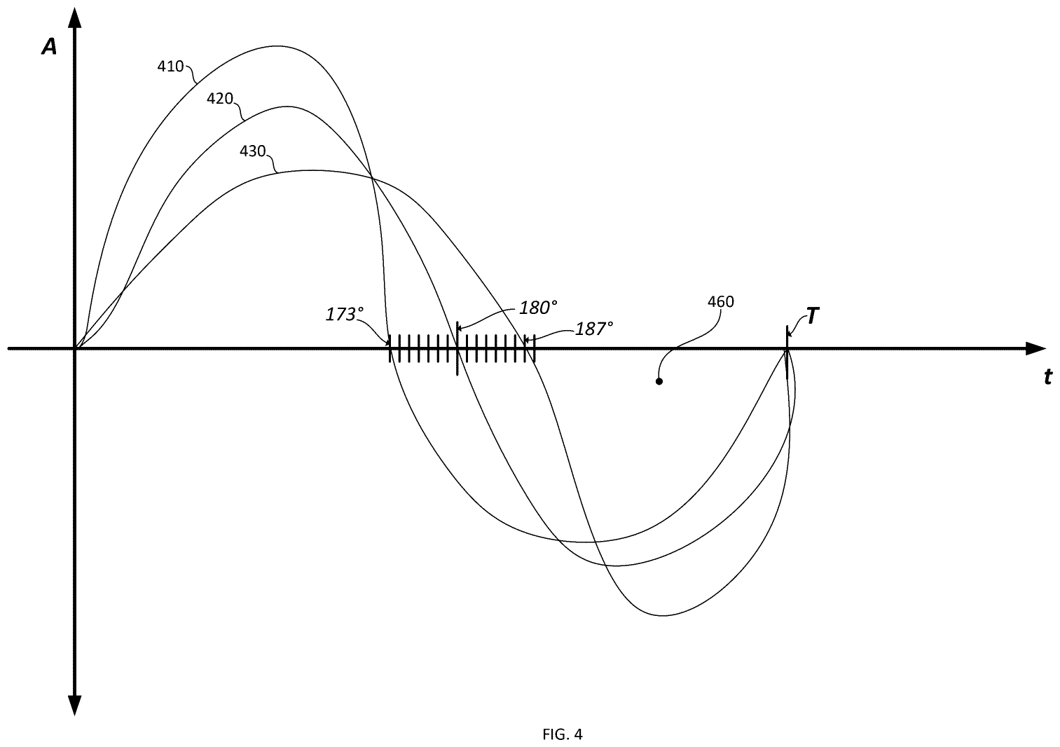

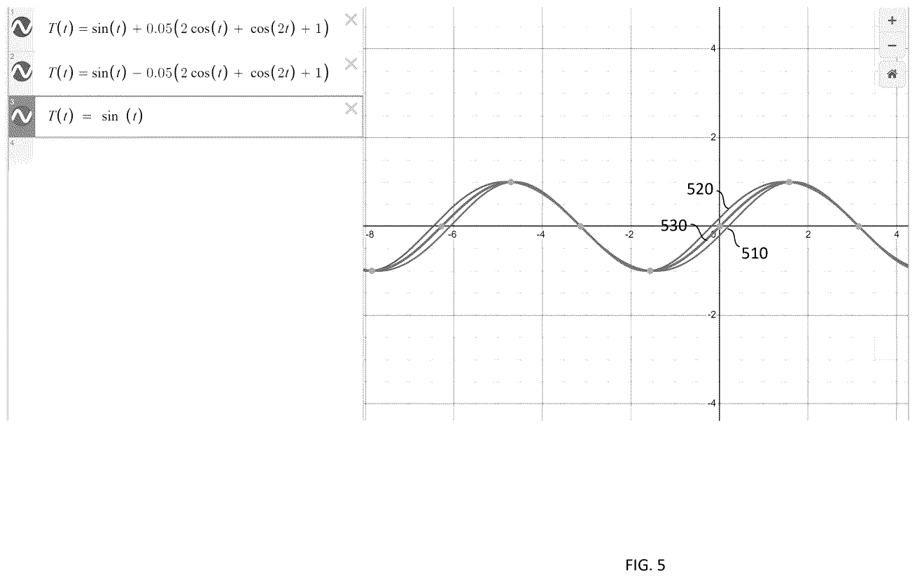

Attention is now directed to FIG. 4, which illustrates a set of zero-crossing modulated waveforms in accordance with the disclosure. In the embodiment of FIG. 4, each waveform is of period T and crosses zero at one of sixteen potential zero-crossing phases. In one embodiment a set of sixteen waveforms having different zero crossing phases and identical periods T are employed as modulation symbols. In particular, each symbol waveform may uniquely represent a 4-bit data word corresponding to the zero-crossing phase of the waveform. For example, a first quasi-sinusoidal waveform 410 of the sixteen zero-crossing modulated waveforms having a zero-crossing phase of 173° could represent the data word [1001]. A second zero-crossing modulated waveform 420 having a zero-crossing phase of 180° could, for example, represent the data word [0000], and a third zero-crossing modulated waveform 430 having a zero-crossing phase of 187° could represent the data word [0111]. As noted above, in some embodiments each period of an encoded waveform comprised of the zero-crossing modulated waveforms of FIG. 4 is of an identical period T while in other embodiments the periods of the waveform may differ slightly from T (e.g., within 1 or 2 degrees). In order to enhance the clarity of FIG. 4 the range of zero crossings have not been drawn to scale. This has the effect of distorting the shapes of the zero-crossing modulated waveforms depicted in FIG. 4 from the shapes they would otherwise assume.

In other embodiments each zero-crossing modulated waveform is configured to cross zero at one of two points encompassing 180 degrees. For example, in a first embodiment a logical “0” data value could be represented by a zero-crossing modulated waveform having a zero crossing of 179 degrees and a logical “1” data value could be represented by a zero-crossing modulated waveform having a zero crossing of 181 degrees. In a first embodiment a logical “0” data value could be represented by a zero-crossing modulated waveform having a zero crossing of 178 degrees and a logical “1” data value could be represented by a zero-crossing modulated waveform having a zero crossing of 182 degrees, and so on.

Turning now to FIG. 5, an alternate set of zero-crossing modulated waveforms in accordance with an embodiment are illustrated. As shown, FIG. 5 illustrates a first zero-crossing modulated waveform 510 and a second zero-crossing modulated waveform 520. The waveforms 510 and 520 are of the form:

$$T ( t ) = sin ( t ) + b * ( 2 cos ( t ) + cos ( 2 t ) + 1 ) .$$

Each of the waveforms 510 and 520 may be associated with a particular logical data value. For example, in one embodiment the waveform 410 is associated with a logical “0” and reflects a value of b of −0.05. In this embodiment the waveform 420 is associated with a logical “1” and reflects a value of b of 0.05. Also shown for reference is a sinusoidal waveform 430, i.e., T(t)=sin(t). It may be appreciated that other embodiments may utilize different values of b. Moreover, it may be further appreciated that expressions other than T(t) above may be used to represent and generate zero-crossing modulated waveforms capable of conferring the spectral efficiency and other benefits described herein.

In one embodiment the encoded waveform comprised of zero-crossing modulated waveform cycles is directly generated as a sequence of voltage points using a software-defined radio (SDR). This sequence of voltage points may then be provided to a digital to analog converter for generation of a corresponding analog version of the encoded waveform. As indicated above, when digitally generated to define zero-crossing-encoded symbols of the type described herein, such generation substantially avoids the creation of harmonics and sidebands. This is believed to be a significant departure from the prior art, in which conventional modulation of sinusoids induces the creation of harmonics and sidebands of material power. Such conventional techniques then typically require that either the sinusoidal carrier or the sidebands be suppressed or otherwise filtered.

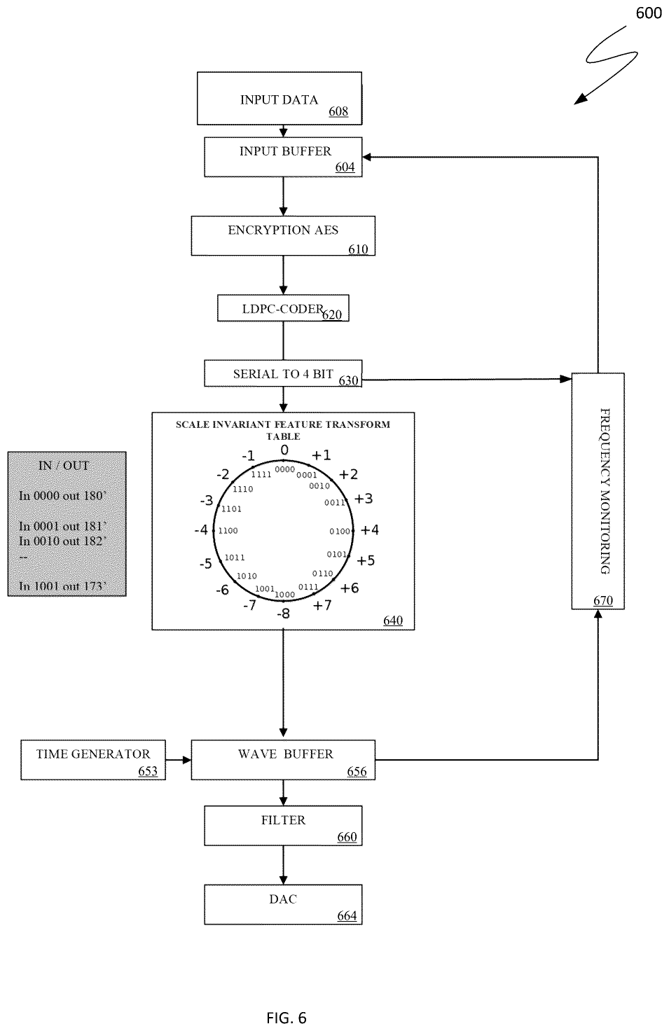

Attention is now directed to FIG. 6, which is a functional block diagram of an embodiment of a transmitter 600 configured to generate and transmit zero-crossing-phase-modulated waveforms. As shown, the transmitter 600 includes an input buffer 604 for storing digital input data 608, a data optimization unit in the form of an AES encryption module 610, an LDPC coder 620 and a serial to 4-bit data word converter 630. In one embodiment the transmitter 600 may be implemented using, for example, an FPGA.

During operation of the transmitter 600, input data has been stored within the input buffer 604 is provided to the AES encryption module 610. In one embodiment the AES encryption module 610 aids in detection of the data at a receiver by processing the input data to limit the run length of strings of the same logical value. The resulting output produced by the AES encryption module 610 is provided to the LDPC coder 620, which performs LDPC error correcting coding operations. The serial data stream produced by the LDPC coder 620 is then converted into a sequence of 4-bit data frames by the serial to 4-bit data word converter 630.

A scale-invariant feature transform table 640 receives each 4-bit data word provided by the serial to 4-bit data word converter 630 and identifies one of 16 zero-crossing-phase-modulated waveforms stored therein corresponding to the 4-bit data word. In one embodiment the table 640 stores data values (e.g., 3600 data values) corresponding to a single period of each of the 16 zero-crossing-phase-modulated waveforms corresponding to each of the 16 possible values of the 4-bit data words provided by the data word converter 630. In response to the sequence of 4-bit data words provided by the data word converter 630, the data values defining each successive zero-crossing modulated waveforms are read from the table 640 and stored within the wave buffer 656. For example, in response to receipt of the 4-bit digital word [1001], the table 640 may be configured to produce, and store within the wave buffer 656, a set of digital values defining the first zero-crossing modulated waveform 2810, which has a zero-crossing phase of 173°.

A time generator 653 provides a clocking signal to the wave buffer 656 so that a relatively constant data rate is maintained into the filter 660. Since the data rate of the input data provided to the input buffer 604 may be somewhat bursty or otherwise irregular, the time generator 653 functions to essentially remove the resulting jitter from the data stream produced by the scale-invariant feature transform table 640 before it is provided to the filter 660.

The zero-crossing modulated waveforms stored within the wave buffer 656 are optionally pre-distorted or otherwise filtered by a filter 660 prior to being converted to analog signals by a digital-to-analog converter 664. The resulting encoded analog signals are transmitted via either a wired or wireless communication medium.

In one embodiment the transmitter 600 includes a frequency monitoring/flow control module 670 operative to control the data rate into the scale-invariant feature transform table 640. Specifically, the flow control module 670 monitors the data rate out of the data converter 630 and into the wave buffer 656. When the data rate out of the data rate converter 630 begins to exceed the data rate into the wave buffer 656, the flow control module 670 sends 4-bit frames from the converter 630 back to the input buffer 604 until these data rates are equalized.

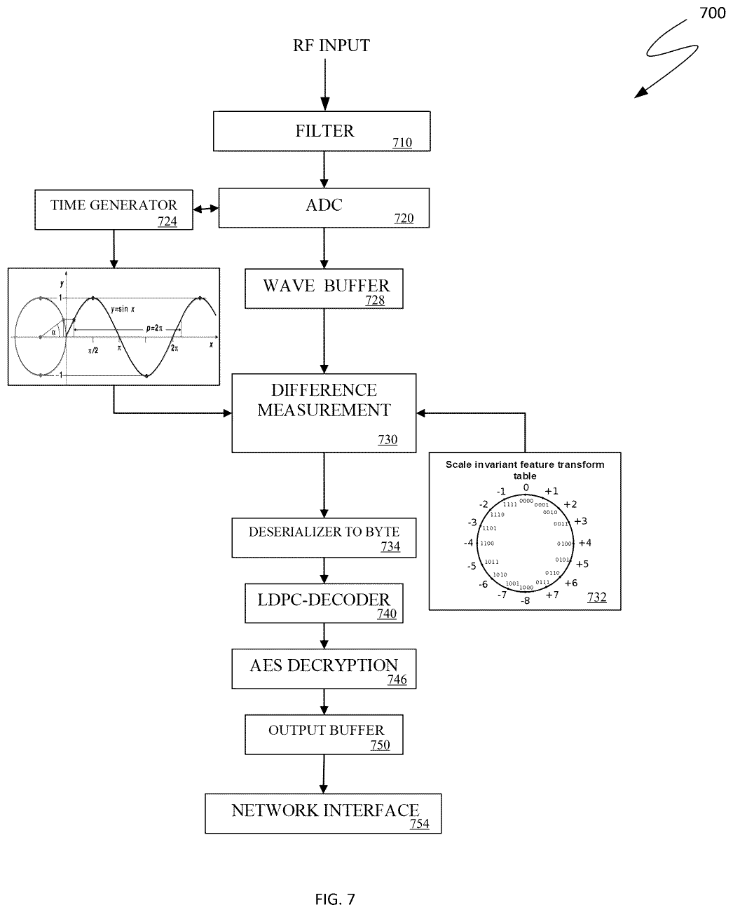

Attention is now directed to FIG. 7, which is a functional block diagram of a receiver 700 configured to receive and demodulate zero-crossing modulated waveforms. In the embodiment of FIG. 7 the receiver 700 is capable of receiving and demodulating zero-crossing modulated waveforms transmitted by the transmitter 600. As shown, the receiver includes a filter 710 which receives such waveforms, filters extraneous channel noise, and provides the filtered result to an analog-to-digital converter (ADC) 720.

A time generator 724 clocks or otherwise controls the output data rate of the ADC 720. Digital amplitude values for each received waveform are generated by the ADC 720 and provided to a wave buffer 728. Once the receiver 700 has achieved time synchronization with a received zero-crossing modulated waveform (e.g., by detecting negative-to-positive zero crossings of the received waveform), the ADC 720 generates samples of the received zero-crossing modulated waveform at a rate based upon the output of a time generator 724. The signal samples produced by the ADC 720 are provided to a wave buffer 728.

Once time synchronization with a received waveform has been achieved, a difference measurement module 730 determines differences between samples of a period of the waveform within the wave buffer 728 and samples of a sine wave of the same period provided by the time generator 724. In a higher-resolution embodiment such differences are determined every 0.1° from 0 to 360° (3600 sample differences per period of the waveform). In lower-resolution embodiments such differences are determined every 1° from 0 to 360° (360 sample differences per period of the waveform). The difference measurement module 730 aggregates these sample differences for a given period and uses the aggregate difference value as an index into a table 732 that stores a data word corresponding to each aggregate difference. For example, in the case in which each period of the received waveform may have one of 16 different positive-to-negative zero crossing phases, the table 732 includes a set of 16 4-bit data words corresponding to each of these zero-crossing phases. That is, each of the aggregated difference values is mapped by the table 732 to one of the 4-bit data words. For example, as shown by the table 732, one of the aggregate difference values could correspond to a “+1” aggregate difference, which is mapped to a data word of 0001. Another of the aggregate difference values could correspond to a “−3” aggregate difference, which is mapped to a data word of 1101, and so on.

In one embodiment sensitivity may be enhanced by configuring the ADC 720 to only operate during certain phase ranges of the received zero-crossing modulated waveforms. In this embodiment, once the receiver 700 has achieved time synchronization with a received zero-crossing modulated waveform, ADC 720 may be gated “on” so as to only generate sample values in the vicinity of the zero crossings proximate the 180° point of each period. For example, the ADC 720 may be turned on only for a time period corresponding to phases spanning the potential zero-crossing phases of interest, e.g., 173° to 187° or slightly wider. Thus, in one embodiment sensitivity is enhanced by configuring the ADC 720 to sample over a relatively small portion of each period.

The data words produced by the measurement module 730 are provided to a deserializer-to-byte unit 734, which produces a series of logical values representing the bit values encoded by the zero-crossing phases of the periods of the received zero-crossing modulated waveform. The logical values generated by the byte unit 734 are then provided to an LDPC decoder 740 configured to remove the LDPC encoding applied by the applicable transmitter (e.g., the transmitter 600) from which the received zero-crossing modulated waveform was transmitted. Similarly, an AES decryption unit 746 reverses the encryption applied by a corresponding AES encryption unit in the applicable transmitter. The output of the AES decryption unit 746 may then be provided to an output buffer 750. In one embodiment the receiver 700 searches bit sequences within the output buffer 750 for a preamble data bit string (e.g., a 0×47 string) signifying the start of a packet. In an exemplary implementation the encoded sine waves received by the receiver 700 carry frames of 1500 bits. Each frame begins with a predefined bit string (e.g., 0×47) and is followed by the data being communicated. Once the preamble has been identified within the output buffer 750, an estimate of the data being communicated may be provided to a local area network (LAN) or the like via a network interface 754. Alternatively, the entire contents of the output buffer 750 may be provided to an external system configured to identify the preamble for each frame and recover the data conveyed by the frame.

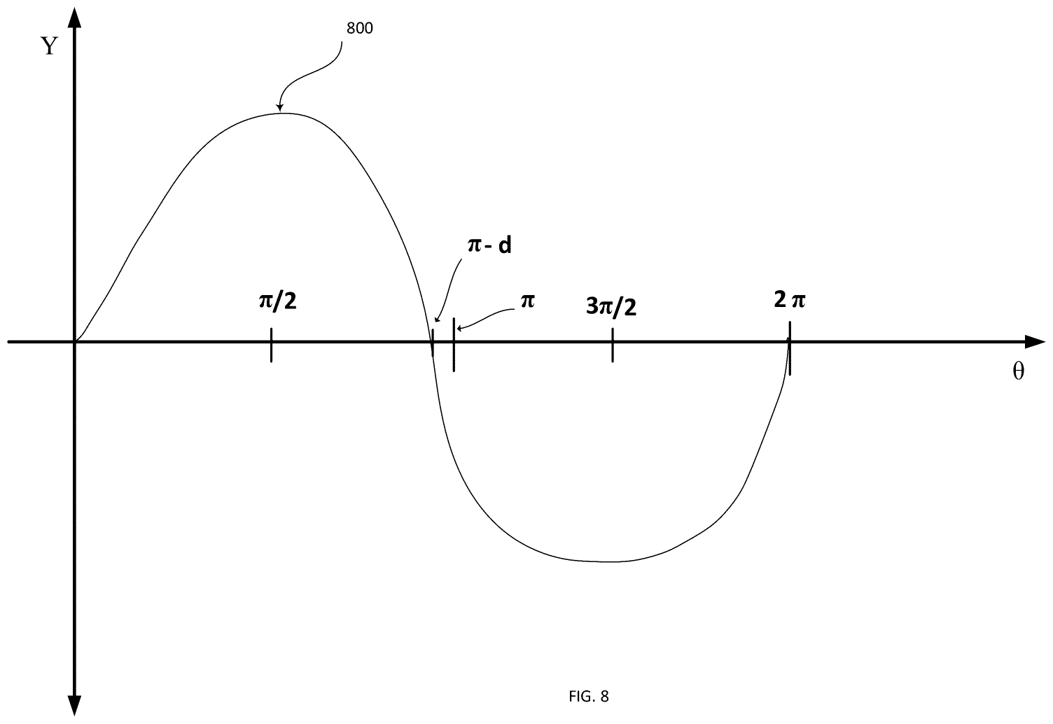

Referring now to FIG. 8, there is illustrated a zero-crossing modulated waveform in the form of a shape-shifted sinusoidal waveform 800 encoded using a continuous piecewise function. As used herein, the term shape-shifted sinusoidal waveform refers to a generally sinusoidal waveform that has been shape-shifted over a defined range of phase angles. In one embodiment a result of this shape-shifting is that sinusoidal waveforms which have been shape-shifted differently have different zero crossing phases (i.e., are of zero value at different phases), and hence may be used to define different modulation symbols. In the embodiment of FIG. 8, the waveform 800 is illustrative of any one of a set of generally sinusoidal waveforms having identical periods but slightly different shapes. Each symbol waveform, such as the shape-shifted sinusoidal waveform 800, may uniquely represent a 4-bit data word corresponding to the zero-crossing phase of the waveform. In one embodiment each symbol waveform is defined by the following continuous piecewise function Y(θ), where θ represents angular displacement and where Y(θ) is continuous between 0 and 2π:

$$Y ( θ ) = ( \begin{matrix}sin ( θ ) & 0 \leq θ \& θ < a \\ f ( θ ) & a \leq θ \& θ < b \\ g ( θ ) & b \leq θ \& θ < c \\ sin ( θ ) & c \leq θ\end{matrix} )$$

where Y is a value of an encoded waveform comprised of equal periods where each symbol waveform occupies one period, θ represents angular displacement, and where:

$$f ( x ) = sin ( π * ( θ - d ) / ( π - 2 d ) ) ,$$

$$g ( x ) = sin ( π * ( θ + 3 d ) / ( π + 2 d ) ) ,$$

$$a = π / 2 ,$$

$$b = π - d ,$$

$$c = 3 π / 2 .$$

The parameter d (which may be a positive or negative value) represents a phase shift which defines the zero crossings of each of the symbol waveforms within their respective periods of the encoded waveform. Thus, each value of d is uniquely associated with a data word, e.g., a 4-bit data word, corresponding to a particular zero crossing phase of an associated one of the symbol waveforms. As shown in FIG. 8, the shape-shifted sinusoidal waveform 800 crosses zero at a phase θ of π−d. Accordingly, when the symbol waveform 800 is used to encode 4-bit data words, a set of sixteen symbol waveforms having different zero crossing phases and identical periods may be employed as modulation symbols, where the value of d associated with each modulation symbol effectively defines the zero crossing of such symbol relative to θ=π. For example, a first symbol waveform 800₁ having a zero-crossing phase of π−d₁ could represent the data word [1001]. A second symbol waveform 800₂ having a zero-crossing phase of π−d₂ could, for example, represent the data word [0000], and a third symbol waveform 800₃ having a zero-crossing phase of π−d₃ could represent the data word [0111].

It has been found that encoded waveforms generated using the function Y, such as the shape-shifted sinusoidal waveform 800, have a very high concentration of signal energy within a very narrow channel bandwidth surrounding the carrier frequency.

The function defining Y defining the shape-shifted sinusoidal waveform 800 is advantageously continuous, which may be shown by evaluating the possible points of discontinuity as follows:

$$sin ( a ) = 1$$

$$f ( a ) = sin ( π * ( ( π / 2 ) - d ) / ( π - 2 d ) ) = sin ( π * ( ( π ) - 2 d ) / 2 ( π - 2 d ) ) = sin ( π / 2 ) = 1.$$

$$f ( b ) = sin ( π * ( ( π - d ) - d ) / ( π - 2 d ) ) = sin ( π * ( ( π - 2 d ) / ( π - 2 d ) ) = sin ( π ) = 0$$

$$g ( b ) = sin ( π * ( ( π - d ) + 3 d ) / ( π + 2 d ) ) = sin ( π * ( ( π + 2 d ) / ( π + 2 d ) ) = sin ( π ) = 0$$

$$g ( c ) = sin ( π * ( 3 π / 2 + 3 d ) / ( π + 2 d ) ) = sin ( 3 π / 2 * ( π + 2 d ) / ( π + 2 d ) ) = sin ( 3 π / 2 ) = - 1$$

$$sin ( c ) = - 1 .$$

Since sin(a)=f(a), f(b)=g(b) and g(c)=sin(c), there are no points of discontinuity. Moreover, at the points a and c, the functions f and g attain their maxima are at a slope of 0. At point b, the slope of f(x) is π/(π−2d) and the slope of g(x) is π/(π+2d). Thus, the function Y is also differentiable at all points except at θ=b.

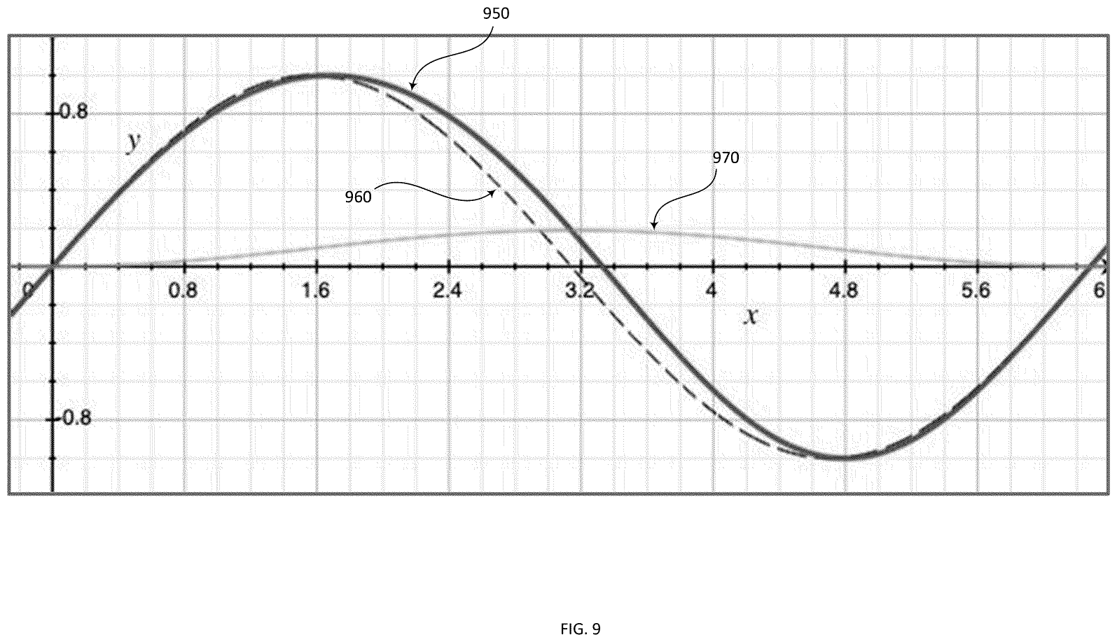

Turning now to FIG. 9, there is illustrated a zero-crossing modulated waveforms in the form of a shape-shifted sinusoidal waveform 950 alternately encoded using a continuous function. The waveform 950, which is shown relative to a sine wave 960, may be shape-shifted to have different zero crossing phases (i.e., are of zero value at different phases) and hence may be used to define different modulation symbols. In the embodiment of FIG. 9, the waveform 950 is illustrative of any one of a set of generally sinusoidal waveforms having identical periods but slightly different shapes. Each symbol waveform, such as the shape-shifted sinusoidal waveform 950, may uniquely represent a 4-bit data word corresponding to the zero-crossing phase of the waveform. In one embodiment each symbol waveform is defined by the following continuous function y(θ), where θ represents angular displacement:

$$y ( θ ) = sin ( θ - a ( 1 - cos ( θ ) ) )$$

$$where$$

$$a = 1 / 2 π s \cdot {sec ( π s / 2 )}^{2} .$$

The parameter s (which may be a positive or negative value) represents a phase shift which defines the zero crossings of each of the symbol waveforms within their respective periods of the encoded waveform. Thus, each value of s is uniquely associated with a data word, e.g., a 4-bit data word, corresponding to a particular zero crossing phase of an associated one of the symbol waveforms. Accordingly, when the symbol waveform 950 is used to encode 4-bit data words, a set of sixteen symbol waveforms having different zero crossing phases and identical periods may be employed as modulation symbols, where the value of s associated with each modulation symbol effectively defines the zero crossing of such symbol relative to θ=π. For example, a first symbol waveform 950₁ having a zero-crossing phase of π−sᵢ could represent the data word [1001]. A second symbol waveform 950₂ having a zero-crossing phase of π−s₂ could, for example, represent the data word [0000], and a third symbol waveform 950₃ having a zero-crossing phase of π−s₃ could represent the data word [0111].

As may be appreciated by reference to FIG. 9, a relative phase shift 970 between sine wave 960 and the phase modulated waveform 950 peaks around the value of θ=π and is essentially zero at values of θ=π and θ=2π, i.e., at the beginning and end of the symbol period. That is, the phase of waveform 950 is modulated relative to the sine wave 960 within a period of the encoded waveform, which may be characterized as intra-periodic or sub-periodic phase modulation. It is this adherence by the sub-periodically modulated waveform 950 to the phase of the sine wave 960 at the beginning and the end of each period which is believed to contribute to the high concentration of energy proximate the carrier frequency within encoded waveforms comprised of a sequence of phase modulated waveforms 950.

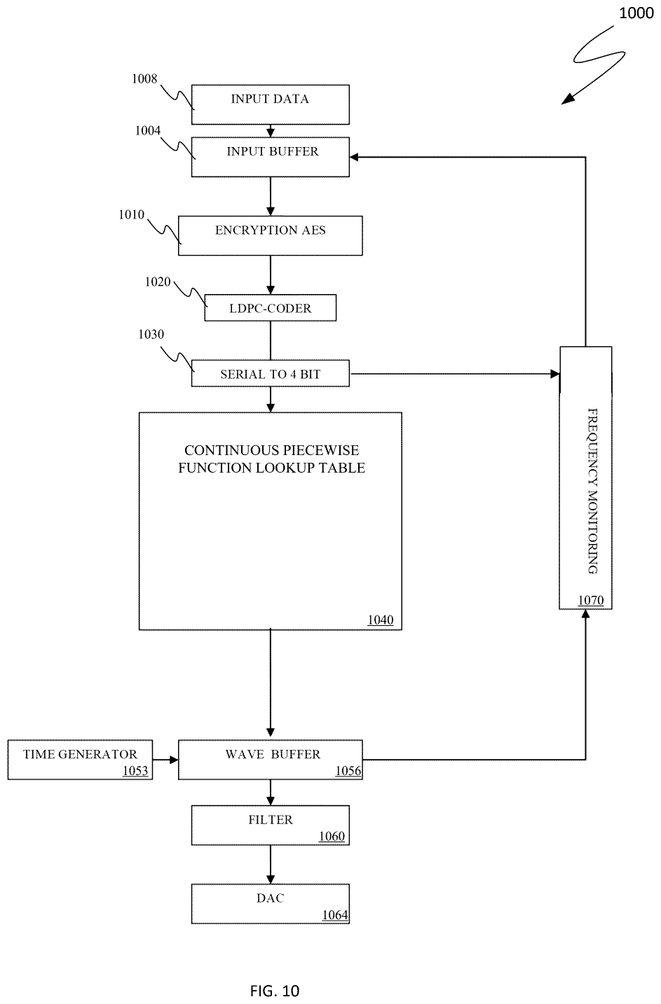

Attention is now directed to FIG. 10, which is a functional block diagram of an embodiment of a transmitter 1000 configured to generate and transmit zero-crossing modulated waveforms in the form of the shape-shifted sinusoidal waveforms illustrated in FIGS. 8 and 9. As shown, the transmitter 1000 includes an input buffer 1004 for storing digital input data 1008, a data optimization unit in the form of an AES encryption module 1010, an LDPC coder 1020 and a serial to 4-bit data word converter 1030. In one embodiment the transmitter 1000 may be implemented using, for example, an FPGA.

During operation of the transmitter 1000, input data has been stored within the input buffer 1004 is provided to the AES encryption module 1010. In one embodiment the AES encryption module 1010 aids in detection of the data at a receiver by processing the input data to limit the run length of strings of the same logical value. The resulting output produced by the AES encryption module 1010 is provided to the LDPC coder 1020, which performs LDPC error correcting coding operations. The serial data stream produced by the LDPC coder 1020 is then converted into a sequence of 4-bit data frames by the serial to 4-bit data word converter 1030.

In embodiments of the transmitter 1000 designed to transmit the waveform 800 of FIG. 8, a continuous piecewise function lookup table 1040 receives each 4-bit data word provided by the serial to 4-bit data word converter 1030 and identifies one of 16 shape-shifted sinusoidal waveforms stored therein corresponding to the 4-bit data word. In one embodiment the table 1040 stores data values (e.g., 3600 data values) corresponding to a single period of each of the 16 shape-shifted sinusoidal waveforms corresponding to each of the 16 possible values of the 4-bit data words provided by the data word converter 1030. In response to the sequence of 4-bit data words provided by the data word converter 1030, the data values defining each successive shape-shifted sinusoidal waveform are read from the table 1040 and stored within the wave buffer 1056. For example, in response to receipt of the 4-bit digital word [1001], the table 1040 may be configured to produce, and store within the wave buffer 1056, a set of digital values defined by evaluating Yₙ(θ) between 0 and 2π where the set of digital values result in a zero-crossing phase of π−dₙ.

In embodiments of the transmitter 1000 configured to transmit the waveform 950 of FIG. 9, the lookup table 1040 could be replaced by an alternate lookup table storing digital representations of 16 shape-shifted sinusoidal waveforms defined by y(θ)=sin(θ−a(1−cos(θ))), where a is defined above.

A time generator 1053 provides a clocking signal to the wave buffer 1056 so that a relatively constant data rate is maintained into the filter 1060. Since the data rate of the input data provided to the input buffer 1004 may be somewhat bursty or otherwise irregular, the time functions to essentially remove the resulting jitter from the data stream produced by the sine wave lookup table 1648 before it is provided to a filter 1060. In one embodiment the transmitter 1000 includes a frequency monitoring/flow control module 1070 operative to control the data rate into the scale-invariant feature transform table 1040. Specifically, the flow control module 1070 monitors the data rate out of the data converter 1030 and into the wave buffer 1056. When the data rate out of the data rate converter 1030 begins to exceed the data rate into the wave buffer 1056, the flow control module 1070 sends 4-bit frames from the converter 1030 back to the input buffer 1004 until these data rates are equalized.

Continuous waveforms stored within the wave buffer 1056 are optionally pre-distorted or otherwise filtered by the filter 1060 prior to being converted to analog signals by a digital-to-analog converter 1064. The resulting encoded analog signals and transmitted via either a wired or wireless communication medium.

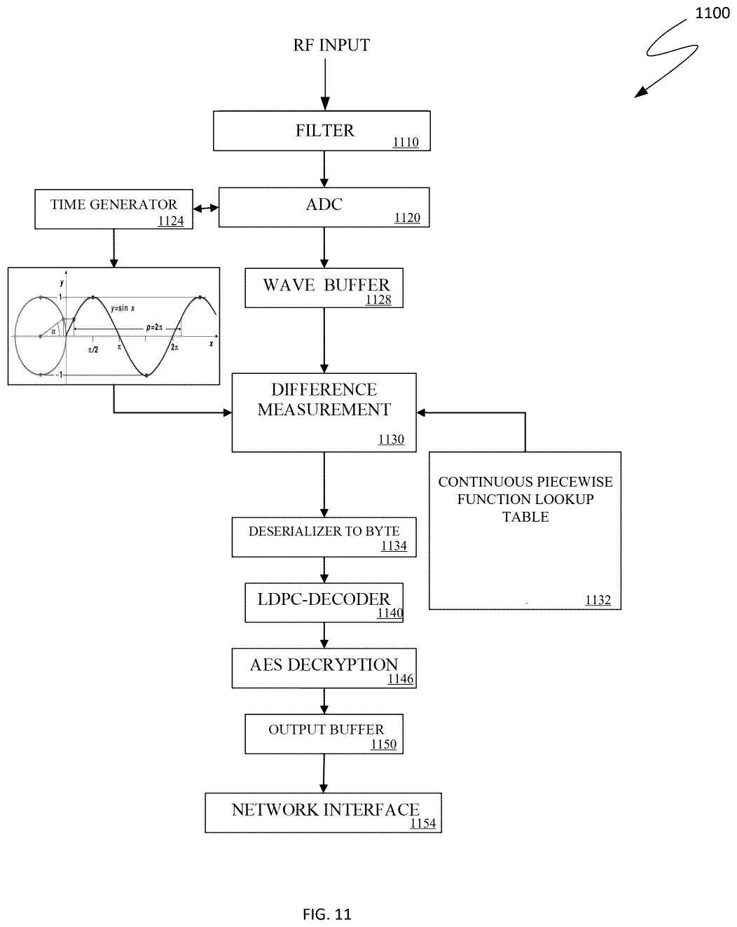

Turning now to FIG. 11. a functional block diagram is provided of a receiver 1100 configured to receive and demodulate zero-crossing modulated waveforms in the form of shape-shifted sinusoidal continuous piecewise waveforms. For example, the receiver 1100 is capable of receiving and demodulating zero-crossing modulated waveforms transmitted by the transmitter 1000 based upon the continuous piecewise function Y(θ) or, alternatively, the continuous function y(θ)=sin(θ−a(1−cos(θ))). As shown, the receiver includes a filter 1110 which receives such waveforms, filters extraneous channel noise, and provides the filtered result to an analog-to-digital converter (ADC) 1120.

A time generator 1124 clocks or otherwise controls the output data rate of the ADC 1120. Digital amplitude values for each received waveform are generated by the ADC 1120 and provided to a wave buffer 1128. Once the receiver 1100 has achieved time synchronization with a received zero-crossing modulated waveform (e.g., by detecting negative-to-positive zero crossings of the received waveform), the ADC 1120 generates samples of the received zero-crossing modulated waveform at a rate based upon the output of a time generator 1124. The signal samples produced by the ADC 1120 are provided to a wave buffer 1128.

Once time synchronization with a received waveform has been achieved, a difference measurement module 1130 determines differences between samples of a period of the waveform within the wave buffer 1128 and samples of a sine wave of the same period provided by the time generator 1124. In a higher-resolution embodiment such differences are determined every 0.1° from 0 to 360° (3600 sample differences per period of the waveform). In lower-resolution embodiments such differences are determined every 1° from 0 to 360° (360 sample differences per period of the waveform). The difference measurement module 1130 aggregates these sample differences for a given period and uses the aggregate difference value as an index into a table 1132 that stores a data word corresponding to each aggregate difference. For example, in the case in which each period of the received waveform may have one of 16 different positive-to-negative zero crossing phases, the table 1132 includes a set of 16 4-bit data words corresponding to each of these zero-crossing phases. That is, each of the aggregated difference values is mapped by the table 1132 to one of the 4-bit data words. For example, as shown by the table 1132, one of the aggregate difference values could correspond to a “+1” aggregate difference, which is mapped to a data word of 0001. Another of the aggregate difference values could correspond to a “−3” aggregate difference, which is mapped to a data word of 1101, and so on.

In one embodiment sensitivity may be enhanced by configuring the ADC 1120 to only operate during certain phase ranges of the received waveforms. In this embodiment, once the receiver 1100 has achieved time synchronization with a received waveform, ADC 1120 may be gated “on” so as to only generate sample values in the vicinity of the zero crossings proximate the 180° point of each period. For example, the ADC 1120 may be turned on only for a time period corresponding to phases spanning the potential zero-crossing phases of interest, e.g., 173° to 187° or slightly wider. Thus, in one embodiment sensitivity is enhanced by configuring the ADC 1120 to sample over a relatively small portion of each period.

The data words produced by the measurement module 1130 are provided to a deserializer-to-byte unit 1134, which produces a series of logical values representing the bit values encoded by the zero-crossing phases of the periods of the received waveform. The logical values generated by the byte unit 1134 are then provided to an LDPC decoder 1140 configured to remove the LDPC encoding applied by the applicable transmitter (e.g., the transmitter 3200) from which the received continuous piecewise waveform was transmitted. Similarly, an AES decryption unit 1146 reverses the encryption applied by a corresponding AES encryption unit in the applicable transmitter. The output of the AES decryption unit 1146 may then be provided to an output buffer 1150. In one embodiment the receiver 1100 searches bit sequences within the output buffer 1150 for a preamble data bit string (e.g., a 0×47 string) signifying the start of a packet. In an exemplary implementation the encoded waveforms received by the receiver 1100 carry frames of 1500 bits. Each frame begins with a predefined bit string (e.g., 0×47) and is followed by the data being communicated. Once the preamble has been identified within the output buffer 1150, an estimate of the data being communicated may be provided to a local area network (LAN) or the like via a network interface 1154. Alternatively, the entire contents of the output buffer 1150 may be provided to an external system configured to identify the preamble for each frame and recover the data conveyed by the frame.

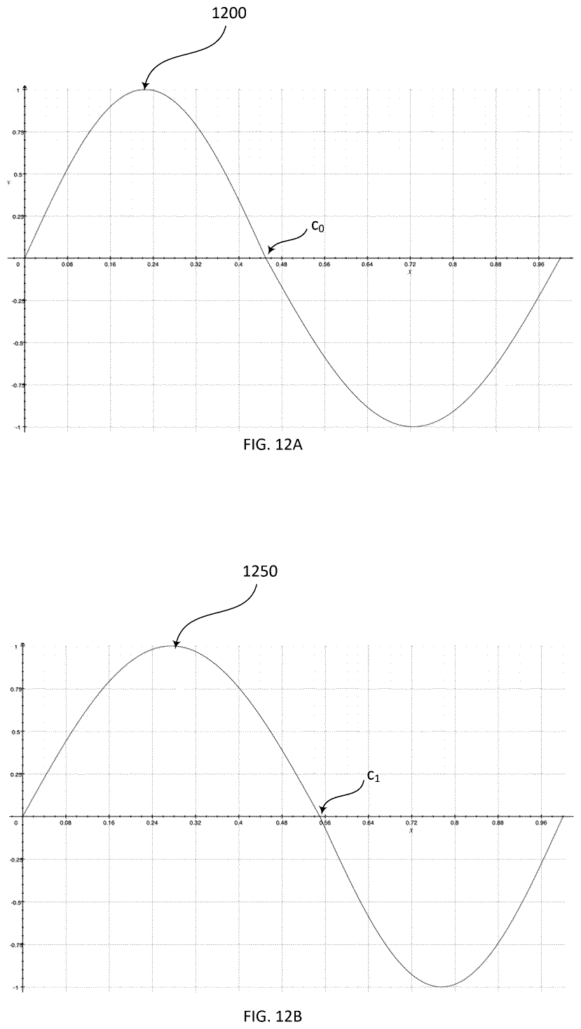

Attention is now directed to FIGS. 12A and 12B, which illustrate zero-crossing waveforms in the form of shape-shifted sinusoidal continuous piecewise waveforms. The shape-shifted sinusoidal waveforms 1200 and 1250 respectively encode two different binary values (e.g., a 0 and a 1). The shape-shifted sinusoidal waveforms 1200 and 1250 may be characterized as being of a wavelength (referred to herein as λ) and as including two half wavelengths λ₁ and λ₂ (one higher and one lower than λ) joined at a point of zero crossing, or “root”. If the bit (b) to be transmitted is a 0, then in one embodiment λ₁ will be shorter than λ₂ (see, e.g., waveform 1200). If a 1 is to be transmitted, then in this embodiment λ₂ will be shorter than λ₁ (see, e.g., waveform 1250). It is noted, however, that λ₁+λ₂=λ. The amount by which λ₁ and λ₂ differ from λis controlled by a parameter, hereinafter referred to a s.

In one embodiment the shape-shifted sinusoidal modulation scheme may also be characterized by two intermediate parameters, derived from b and/or s. The new location of the root is represented by c and the percent change in the x value of that root is represented by s. As an example, in a case in which b=1 and s=0.025, the transmitted shape-shifted sinusoidal waveform may be characterized as follows:

$$b = 1$$

$$λ = 1$$

$$s = 0. 025$$

$$u = ( 2 b - 1 ) s$$

$${λ}_{1} = λ ( 1 + u )$$

$${λ}_{2} = λ ( 1 - u )$$

$$c = \frac{λ}{2} ( 1 + u )$$

$$T ( t ) = \{ \begin{matrix}sin ( \frac{2 π t}{{λ}_{1}} ) & 0 \leq t \& t < c \\ - sin ( \frac{2 π ( t - c )}{{λ}_{2}} ) & c \leq t \& t < λ\end{matrix}$$

The values of s of interest in practical applications (e.g., s=0.025) may result in rather subtle changes in shape in the transmitted shape-shifted waveform relative to a pure sinusoid. Accordingly, in the example of FIGS. 12A and 12B the waveforms 1200 and 1250 were generated with a value of s=1 so as to more clearly illustrate differences in shape-shifted sinusoidal waveforms representing a 0 and a 1. In one embodiment the waveforms FIGS. 12A and 12B could be low-pass filtered prior to transmission so as to remove any noise arising due to non-differentiability of the waveforms at c (denoted by c₁ in FIG. 12A and by c₂ in FIG. 12B).

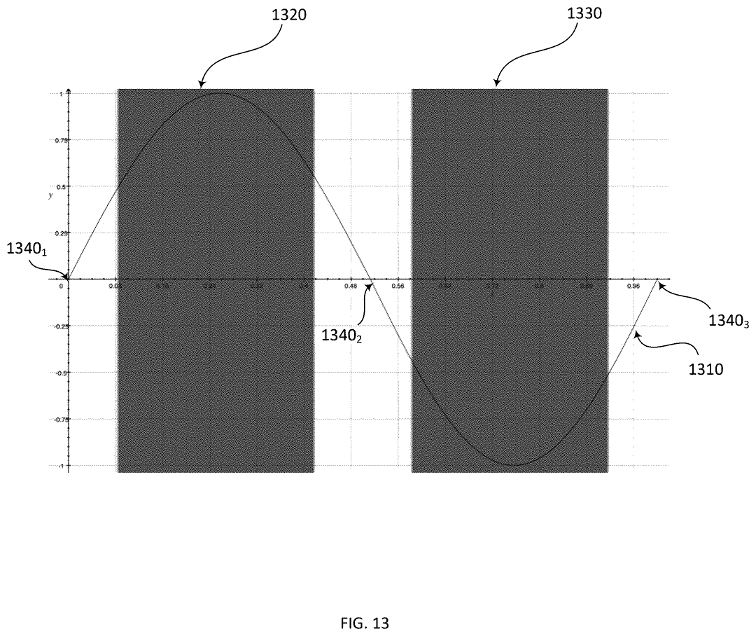

Attention is now directed to FIG. 13, to which reference will be made in describing an exemplary process for decoding information within zero-crossing waveforms in the form of shape-shifted sinusoidal continuous piecewise waveforms. A shape-shifted shifted sinusoid 1310 represents a shape-shifted shifted sinusoid generated and transmitted by a transmitter and received by a receiver. As shown, a first integration interval 1320 and a second integration interval 1330 are defined relative to the shape-shifted sinusoid 1310. In one embodiment edges of these intervals occur at a predefined number of degrees (e.g., ±15 degrees) from the roots 1340, or zero crossings, of a pure sine wave of wavelength λ. Within the receiver a comparison is made of the two integrals of the squares of the amplitude of the shape-shifted shifted sinusoid 1310 across the two intervals 1320 and 1330. This may, for example, involve computing the sum of the squares of samples of the shape-shifted shifted sinusoid 1310 across the intervals 1320 and 1330. If the value of the integral computed over the first integration interval 1320 is larger than the integral value computed over the second integration interval 1330, it is inferred that a one (1) was transmitted, i.e., λ₂ shorter than λ₁, and that otherwise a zero was transmitted. In the example of FIG. 13, the shape-shifted shifted sinusoid 1310 has been synthesized to encode a one (1) using a value of s (i.e., s=2.5%) suitable for a practical application.

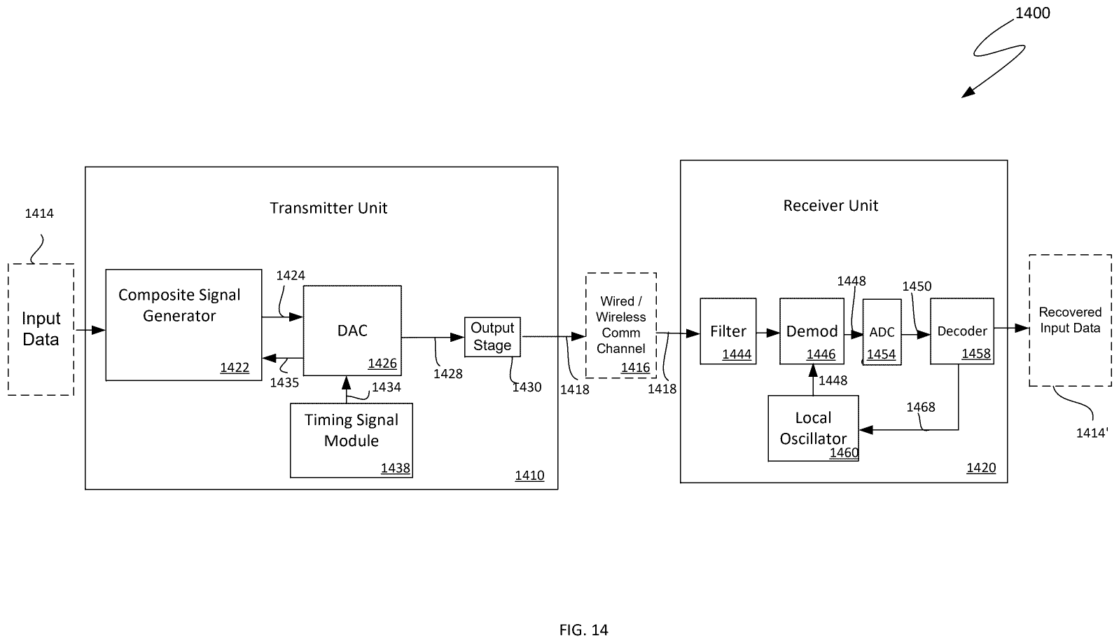

FIG. 14 is an embodiment of a communication system 1400 configured to embed auxiliary message waveforms within unconcealed modulated signals. The system 1400 includes a transmitter unit 1410 operative to receive input data 1414 and to generate and transmit, over a communication link 1416, a composite signal transmission 1418 comprised of an auxiliary message waveform interleaved with an unconcealed modulated signal. A receiver unit 1420 receives the composite signal 1418 and recovers an estimate 1414′ of the input data 1414 by decoding the auxiliary message waveform. The receiver unit 1420 may output the recovered input data 1414′ to some other device, such as, by way of example only, a monitor, a computer, an audio component, or a speaker. The communications link 1416 may be provided by media such as coaxial cable, fiber optic cable, telephone or telephone company (telco) lines such as copper wires, open air as by radio frequency or space or satellite.

The transmitter unit 1410 includes a composite signal generator 1422 operative to generate a digital composite signal 1424 that is converted by a digital-to-analog converter (DAC) 1426 into an analog composite signal 1428. The analog composite signal 1428 is processed by an output stage 1430 and transmitted as the composite signal transmission 1418. The DAC 1426 is clocked by a modulated timing signal 1434 provided by a timing signal module 1438. In one embodiment the modulated timing signal 1434 is a frequency-modulated signal. The DAC 1426 also provides the timing signal 1434 to the composite signal generator 1422 as the timing signal 1435.

As is described in further detail below, the digital composite signal 1424 includes a modulated signal having a frequency determined by the modulation timing signal 1435. The digital composite signal 1424 further includes a stream of waveform data defining an auxiliary zero-crossing-modulated waveform having a frequency that is typically much lower than the frequency of the digital composite signal 1424. For example, in an embodiment in which the modulated signal is derived from a modulation timing signal 1435 modulated in frequency about a nominal frequency of 423 MHz, the frequency of the zero-crossing-modulated waveform could be, for example, 2 MHz. It will be appreciated that these frequencies are only exemplary and that in other embodiments both the digital composite signal and the zero-crossing-modulated waveform could be substantially higher or lower in frequency.

The receiver unit 1420 includes a filter 1444 configured to receive and filter the composite signal transmission 1418. The resultant filtered signal (e.g., at 425 MHz) is provided to a demodulator 1446 disposed to produce a signal 1448 at the frequency of the auxiliary zero-crossing modulated waveform (e.g., at 2 MHz). The signal 1448 is converted to digital signals 1450 by an analog to digital converter 1454 and decoded by a decoder module 1458 to yield recovered input data 1414′. The demodulator 1446 also receives a modulated reference signal 1448 from a local oscillator 1460 that may operate at a nominal frequency equivalent to the nominal frequency of the modulation timing signal 1434 (e.g., 423 MHz). The decoder module 1458 also generates a correction signal 1468 that mimics a source of phase modulation used in generating the modulation timing signal 1434. In this way the local oscillator 1460 is induced to increase and decrease in frequency in concert with and to compensate for the frequency shifts occurring within the demodulator 1446. This effectively removes the frequency modulated signal from the received composite signal transmission 1418 and thereby yields the signal 1448 (which may include I and Q signal components) at the frequency of the auxiliary zero-crossing modulated waveform within the digital composite signal 1424. In the case of the exemplary system discussed above, these operations would remove the frequency modulated signal at 423 MHz from the received composite signal transmission 1418 at 425 MHz and thereby yield a 2 MHz signal 1448 containing I and Q components of the zero-crossing modulated waveform.

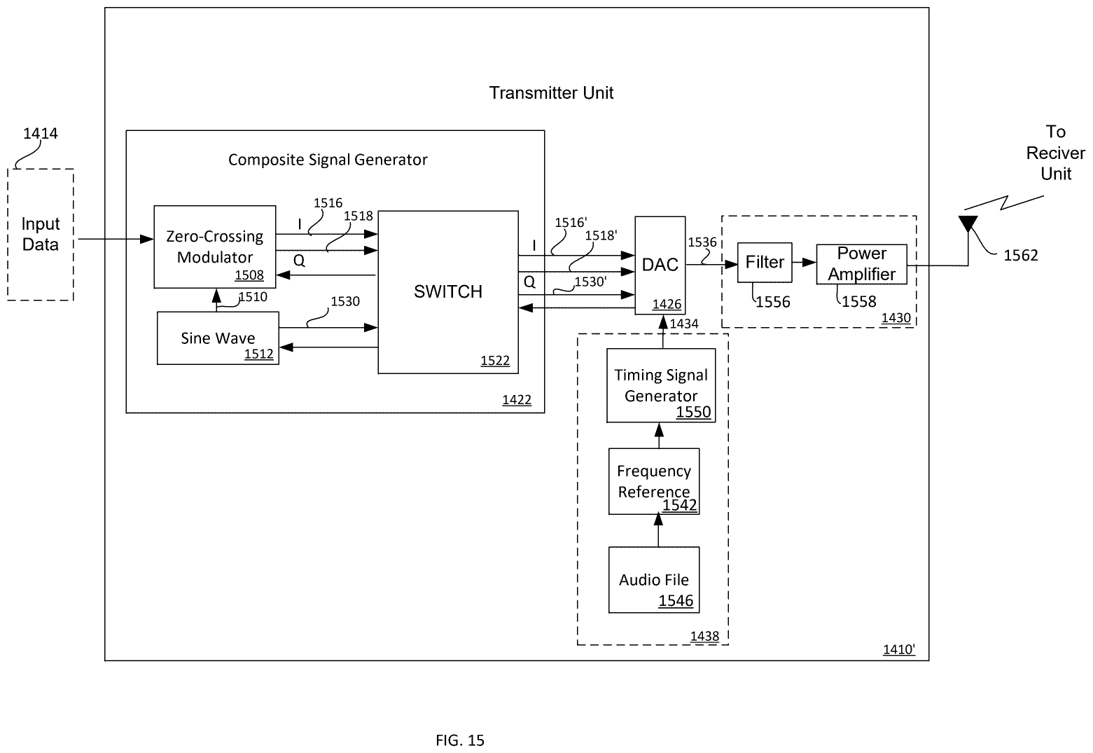

Attention is now directed to FIG. 15, which provides a detailed representation of a transmitter unit 1410′ corresponding to a particular embodiment of the transmitter unit 1410. In the embodiment of FIG. 15 the composite signal generator 1422 includes a zero-crossing modulator 1508 disposed to receive digital data 1510 defining a sine wave from a sine wave source 1512. The zero-crossing modulator 1508 produces, based upon the input data 1414, I and Q data 1516, 1518 defining zero-crossing-modulated quasi sinusoids in accordance with the disclosure. As shown, the I and Q data 1516, 1518 defining the zero-crossing-modulated quasi sinusoids generated by the zero-crossing modulator 1508 are provided to a switch 1522. During operation of the composite signal generator 1422, the switch 1522 receives sine wave data 1530 provided by the sine wave source 1512 and sends multiple periods (e.g., 100 or 200 periods, etc.) of sine wave data 1530′ to the DAC 1426. After data 1530′ defining a predefined number of sine wave periods (e.g., 100 or 200 periods) is forwarded by the switch 1522 to the DAC 1426, the switch 1522 sends I and Q data 1516′, 1518′ defining a predefined number of periods (e.g., 1, 2 or 10 periods) of zero-crossing-modulated quasi-sinusoids to the DAC 1416. In this way one or more periods of the zero-crossing-modulated quasi-sinusoids are effectively inserted between a larger number of consecutive periods of the sine wave periods 1530′.

The DAC 1426 generates an analog composite signal 1536 which includes periods of the zero-crossing-modulated quasi-sinusoids corresponding to the I and Q data 1516′, 1518′ separated by a larger number of consecutive analog sine wave periods corresponding to the sine wave data 1530′. The timing of the DAC 1416 is synchronized to the modulation timing signal 1434 provided by the timing signal module 1438. As a consequence, the periods of the analog sine waves within the composite signal 1536 will vary in accordance with the modulation timing signal 1434. Stated differently, the composite signal 1536 will include a modulated signal, e.g., a frequency modulated (FM) signal comprised of at least the analog sine wave periods corresponding to the sine wave data 1530′. Because the composite signal 1536 may include 100 or 200 periods of this FM signal between every period of the zero-crossing-modulated quasi-sinusoids defined by the I and Q data 1516′, 1518′, it may be appreciated that the zero-crossing-modulated quasi-sinusoids defined by the I and Q data 1516′, 1518′ may form a type of auxiliary message embedded within the unconcealed FM signal with the composite signal 1536.

In the embodiment of FIG. 15 the timing signal module 1438 includes a frequency reference 1542 modulated in frequency by the contents of an audio file 1546, e.g., an MP3 file. The timing signal module 1438 further includes a timing signal generator 1550 configured to produce the modulation timing signal 1434 based upon the modulated output of the frequency reference 1542. For example, in one embodiment the frequency reference 1542 could provide a frequency modulated frequency reference having a nominal frequency of 10 MHz. This frequency modulated reference could then be used by the timing signal generator 1550 to produce a frequency modulated square wave at a substantially higher frequency, e.g., 2.4 GHz.

The output stage 1430 includes a filter 1556 configured to filter the composite signal 1536 produced by the DAC 1426. The filtered signal produced by the filter 1556 is then amplified by a power amplifier 1558 and transmitted via antenna 1562.

In one embodiment the zero-crossing-modulated quasi-sinusoids corresponding to the I and Q data 1516, 1518 are very nearly, but not exactly, sinusoidal in that the zero crossing of the waveform varies between periods (e.g., within +/−9 degrees of 180 degrees) in accordance with the input data 1414. Each period of the zero-crossing-modulated quasi-sinusoids corresponding to the I and Q data 1516, 1518 may be of identical duration. However, in other embodiments each such period of the zero-crossing-modulated quasi-sinusoids will generally be of approximately the same duration T, but not necessarily of identical duration. In such embodiments the duration of the average period of the zero-crossing-modulated quasi-sinusoids over a suitably large number of cycles will be substantially equivalent or identical to T. In the embodiment of FIG. 15, each period of the zero-crossing-modulated quasi-sinusoids corresponding to the I and Q data 1516, 1518 is representative of one bit of the input data 1414. In other embodiments the same bit of input data 1414 may be repeated in multiple cycles of the zero-crossing-encoded quasi-sinusoids generated by the zero-crossing modulator 1508.

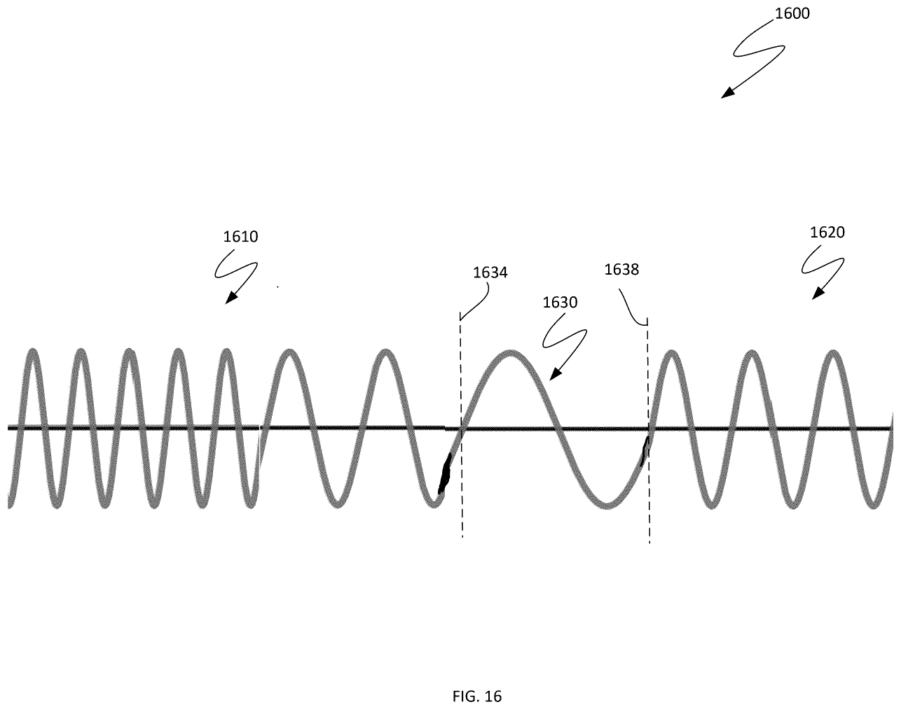

Attention is now directed to FIG. 16, which illustrates multiple periods of an exemplary analog composite signal 1600 generated in accordance with the disclosure. The composite signal 1600 includes a frequency modulated (FM) signal including a first series of periods 1610 and a second series of period 1620. The composite signal 1600 further includes a period 1630 of a zero-crossing-modulated quasi-sinusoid generated in accordance with the disclosure. As shown, the period 1630 of the zero-crossing-modulated quasi-sinusoid is interposed between the periods 1610, 1620 of the FM signal. As may be appreciated from FIG. 16, the period 1630 of the zero-crossing-modulated quasi-sinusoid is inserted at zero crossings 1634, 1638 of the analog composite signal 1600. In other embodiments multiple periods of the zero-crossing modulated waveform are interposed between each series of periods of the modulated signal. In yet other embodiments the FM signal may be replaced by a signal modulated in accordance with a different modulation scheme (e.g., ATSC, DVB, AM, n-QAM, BPSK, 4PSK, 8PSK, 16PSK).

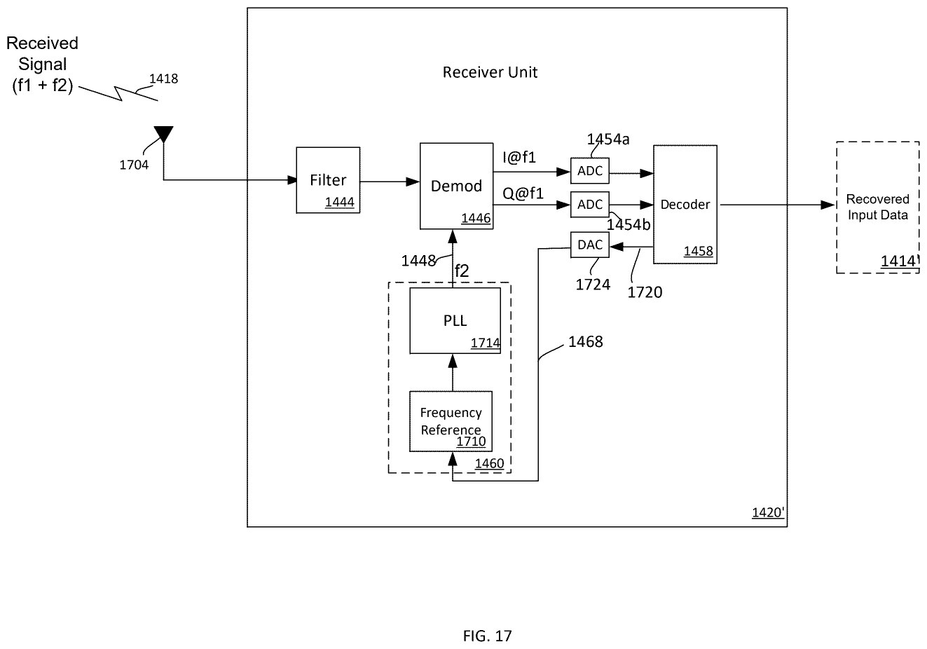

Attention is now directed to FIG. 17, which provides a detailed representation of a receiver unit 1420′ corresponding to particular embodiment of the receiver unit 1420. As shown, the receiver unit 1420′ includes an antenna 1704 that receives the composite signal transmission 1418 and provides it to the filter 1444. The resultant filtered signal (e.g., at 425 MHz) is provided to the demodulator 1446, which in the embodiment of FIG. 17 produces I and Q signals at the frequency (f1) of the zero-crossing modulated waveform (e.g., 2 MHz). The I and Q signals are converted to digital signals by analog to digital converters 1454a, 1454b and decoded by the decoder module 1458 to yield the recovered input data 1414′.

The demodulator 1446 also receives the modulated reference signal 1448 from the local oscillator arrangement 1460, which includes a frequency reference 1710 and a phase-locked loop (PLL) 1714. The decoder module 1458 also generates a digital correction signal 1720 that is converted by a digital to analog converted (DAC) 1724 into the correction signal 1468. Again, the correction signal 1468 mimics a source of phase modulation used in generating the modulation timing signal 1434. The correction signal 1468 modulates the frequency of the frequency reference 1710. This causes the frequency reference 1710 and the PLL 1714 to produce the modulated reference signal 1448 at a nominal frequency (f2). The frequency f2 may be equivalent to the nominal frequency of the modulation timing signal 1434 (e.g., 423 MHz). In one embodiment the PLL 1714 may operate at, for example, twice the nominal frequency of the modulated reference signal 1448 (i.e., at 2f2).

The correction signal 1468 causes the modulated reference signal 1448 to increase and decrease in frequency in concert with, and to compensate for, the frequency shifts occurring within the demodulator 1446. This effectively removes the frequency modulated signal from the received composite signal transmission 1418 and thereby enables the demodulator 1446 to produce the I and Q signals at f1, i.e., at the frequency of the zero-crossing modulated waveform within the digital composite signal 1424. In the case of the exemplary system discussed above, these operations would remove the frequency modulated signal at 423 MHz from the received composite signal transmission 1418 at 425 MHz and thereby yield I and Q components of the zero-crossing modulated waveform at an f1 of 2 MHz.

It may thus be appreciated that the receiver unit 1420 functions as a digital automatic frequency correction (AFC) circuit. That is, once phase and frequency lock is obtained with the FM signal included within the received analog composite signal, the received analog composite signal may effectively be multiplied by the phase locked FM signal to yield the zero-crossing modulated signal.

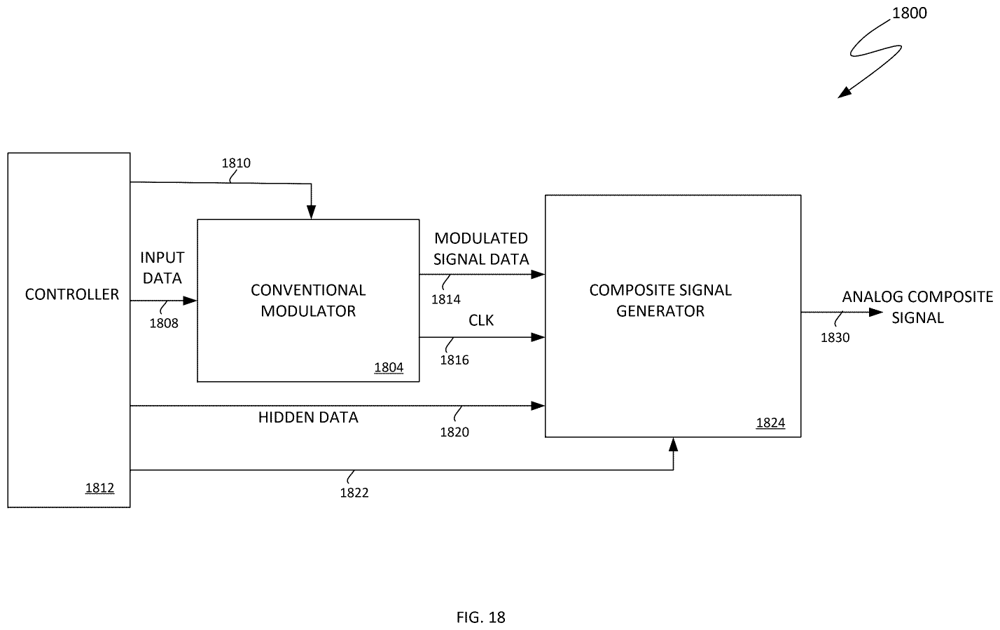

FIG. 18 is a block diagram representative of a transmitter 1800 configured to embed auxiliary message waveforms within conventionally modulated communication signals in accordance with an embodiment. The transmitter 1800 includes a conventional modulator 1804 which receives input data 1808 and control signals 1810 from a controller 1812. The conventional modulator 1804 generates, based upon the input data 1808, modulated signal data 1814 conforming to a conventional signal modulations scheme such as, for example, QPSK, PSK, ATSC, DVB-2, and the like. The controller 1812 also provides auxiliary data 1820 and control signals 1822 to a composite signal generator 1824. The composite signal generator 1824 also receives the modulated signal data 1814 and a clock signal 1816 from the conventional modulator 1804. As is discussed in greater detail below, the composite signal generator 1824 produces a composite signal 1830 by replacing portions of the modulated signal data 1814 with auxiliary message waveforms generated based upon the auxiliary data 1820. Advantageously, the auxiliary data 1820 is unable to be extracted from the auxiliary message waveforms within the composite signal 1830 by eavesdroppers or other unintended recipients of the composite signal 1830.

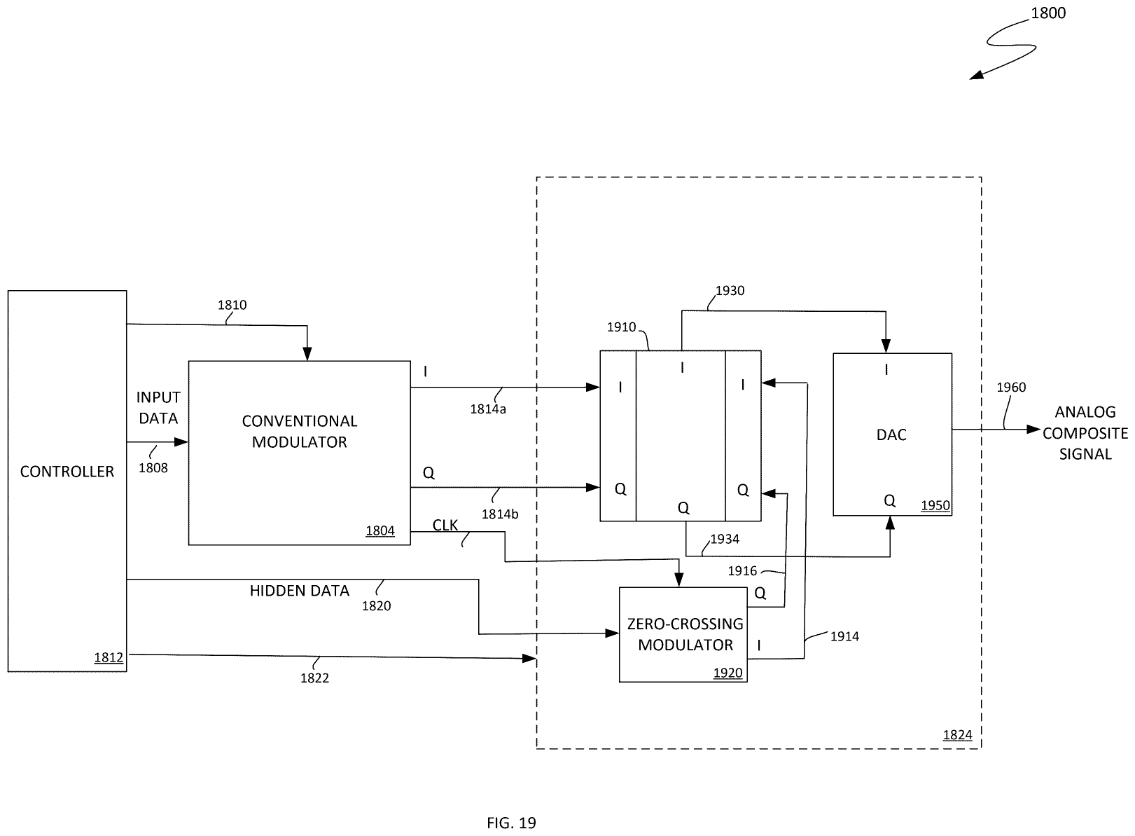

Attention is now directed to FIG. 19, which provides a detailed representation of a transmitter unit 1800 corresponding to a particular embodiment of the transmitter unit 1410. In the embodiment of FIG. 19 the modulated signal data 1814 produced by the conventional modulator 1804 is in the form of in-phase (I) modulated signal data 1814a and quadrature-phase (Q) modulated signal data 1814b that is provided to an IQ mixer module 1910 within the composite signal generator 1824. Although in conventional modulation protocols it is generally the case that each period of the underlying carrier wave of the modulated signal will be perturbed in one or more of phase, frequency and amplitude relative to an unmodulated sine wave, there nonetheless exist “stray” unmodulated sine wave periods within the modulated signal. For example, in a modulated ATSC data stream a relatively small percentage (e.g., less than 4% in many implementations) of the I and Q data defining the ATSC data stream appear to resemble unmodulated sine waves for brief periods, which may be attributable to the occurrence of specific symbol combinations.

In the embodiment of FIG. 19 the IQ mixer module 1910 is configured to monitor the I modulated signal data 1814a and Q modulated signal data 1814b for the presence of such apparently unmodulated sine waves. When data defining such an unmodulated sine wave is detected in either the I modulated signal data 1814a or Q modulated signal data 1814b, the IQ mixer module 1910 replaces such unmodulated sine wave data with either I or Q replacement data 1914, 1916 provided by a zero-crossing modulator 1920. The I or Q replacement data 1914, 1916 produced by the zero-crossing modulator 1920 defines zero-crossing-modulated quasi-sinusoids in response to the auxiliary data 1820. If the IQ mixer module 1910 detects data defining an unmodulated sine wave in the I modulated signal data 1814a, such detected data is replaced with I replacement data 1914 corresponding to one period of a zero-crossing modulated waveform of the type described herein. Conversely, if the IQ mixer module 1910 detects data defining an unmodulated sine wave in the Q modulated signal data 1814b, such detected data is replaced with Q replacement data 1916 corresponding to one period of a zero-crossing modulated waveform. In this way the IQ mixer 1910 produces an I composite data stream 1930 which will be substantially the same as the I modulated signal data 1814a, with the exception that the I composite data stream 1930 will include I replacement data 1914 during those periods of the I modulated signal data 1814a appearing as unmodulated sine wave data. Similarly, the IQ mixer 1910 produces a Q composite data stream 1934 which will be substantially the same as the Q modulated signal data 1814b, with the exception that the Q composite data stream 1934 will include Q replacement data 1916 during those periods of the Q modulated signal data 1814b appearing as unmodulated sine wave data. As shown, a complex IQ digital-to-analog converter (DAC) 1950 produces an analog composite output signal 1960 based upon the I composite data stream 1930 and the Q composite data stream 1934.

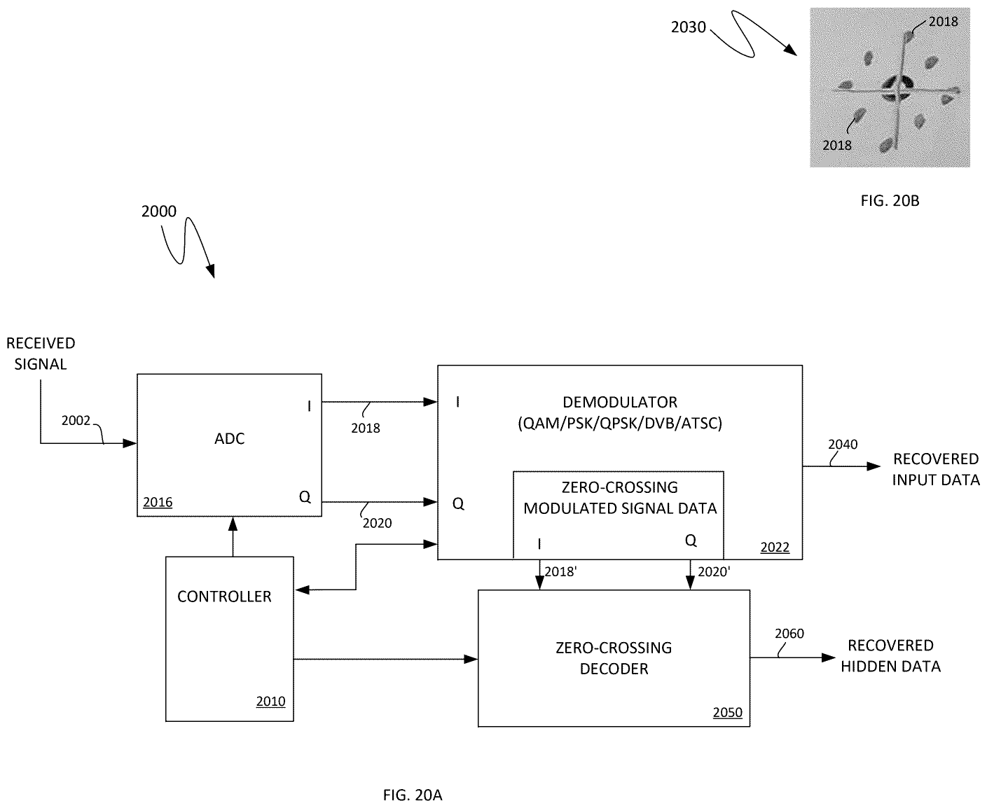

As may be appreciated from the preceding discussion, the analog composite output signal 1950 encodes both the input data 1808 and the auxiliary data 1820. Although a conventional receiver may be configured to receive and demodulate the analog composite signal 1960, a conventional receiver would not detect the auxiliary data 1820. This is because the auxiliary data 1820 is encoded by subtle phase shifts in the carrier signal utilized in creating the I modulated signal data 1814a and the Q modulated signal data 1814b. As a consequence, the auxiliary data 1820 may be covertly conveyed by the analog composite signal 1960 and only recovered using a receiver specially configured to decode pertinent portions of the carrier signal present within the analog composite signal 1960 in the manner described below with reference to FIGS. 20A and 20B.

FIG. 20A is a block diagram representative of a receiver 2000 configured to recover auxiliary message waveforms embedded within carrier signals of communication signals in accordance with an embodiment. In one embodiment the receiver 2000 is configured to receive an analog communication signal 2002 having a phase-modulated carrier signal encoding a auxiliary message waveform. For example, in some embodiments the analog communication signal 2002 could have characteristics substantially similar or identical to the analog composite signal 1960. As shown in FIG. 20A, the receiver 2000 includes a controller 2010 responsible for coordinating the operation of all modules within the receiver 2000. In one embodiment the controller 2010 is in the form of a field programmable gate array (FPGA) or an application specific integrated circuit (ASIC). The receiver 2000 further includes an analog-to-digital converter (ADC) 2016 which digitizes the received analog communication signal 2002 into an in-phase (I) sample stream 2018 and a quadrature-phase (Q) sample stream 2020. The I sample stream 2018 and Q sample stream 2020 are provided to a demodulator 2022 configured to perform demodulation operations in accordance with the protocol or standard used to modulate the received analog communication signal 2002 (e.g., QAM/PSK/QPSK/DVB/ATSC).

Timing of the receiver 2000 may be established in a number of ways. In embodiments in which the phase of the phase-modulated carrier of the analog communication signal 2002 is substantially identical to a sinusoidal carrier during some portion of each of its periods (e.g., between 0 and 90 degrees and/or between 270 and 360 degrees), the phase-modulated carrier of the communication signal 2000 may be sampled during these portions of some or all of its periods. The resulting samples may then be used to generate a local reference carrier signal or phase. In other embodiments a purely sinusoidal pilot signal having a frequency relatively close to but different than the frequency of the phase-modulated carrier of the communication signal 2002 is sampled used to establish timing in the receiver 2000.

During the demodulation process performed by the demodulator 2022, the results of the demodulation process may be monitored in order to detect instances of valid and invalid modulation symbols. For example, in cases in which the analog communication signal 2002 is modulated using 8 phase-shift keying (8 PSK) modulation, the applicable constellation diagram 2030 is depicted in FIG. 20B. As shown in the constellation diagram 2030, there exist a set of 8 valid constellation points 2034 when 8 PSK modulation is utilized. When the controller 2010 determines that the demodulation 2022 has detected that the results of the demodulation process yield a valid constellation point 2034, the controller 2010 causes the demodulator 2022 to output data bits corresponding to the valid constellation point 2034 as recovered data 2040. If on the other hand the results of the demodulation process yield a point in the ring 2038 in the constellation diagram 2030, then it is inferred that at least one phase-modulated period of the carrier signal inherent in the communication signal 2022 has been received. In this case the controller 2010 causes the corresponding I data 2018′ and Q data 2020′ to be provided to a zero-crossing decoder 2050, which decodes the phase shift in the period of the carrier signal to produce recovered auxiliary data 2060. Such decoding may be carried out by the zero-crossing decoder 2050 consistent with, for example, the exemplary decoding methods described with reference to FIGS. 7, 11 and 13.

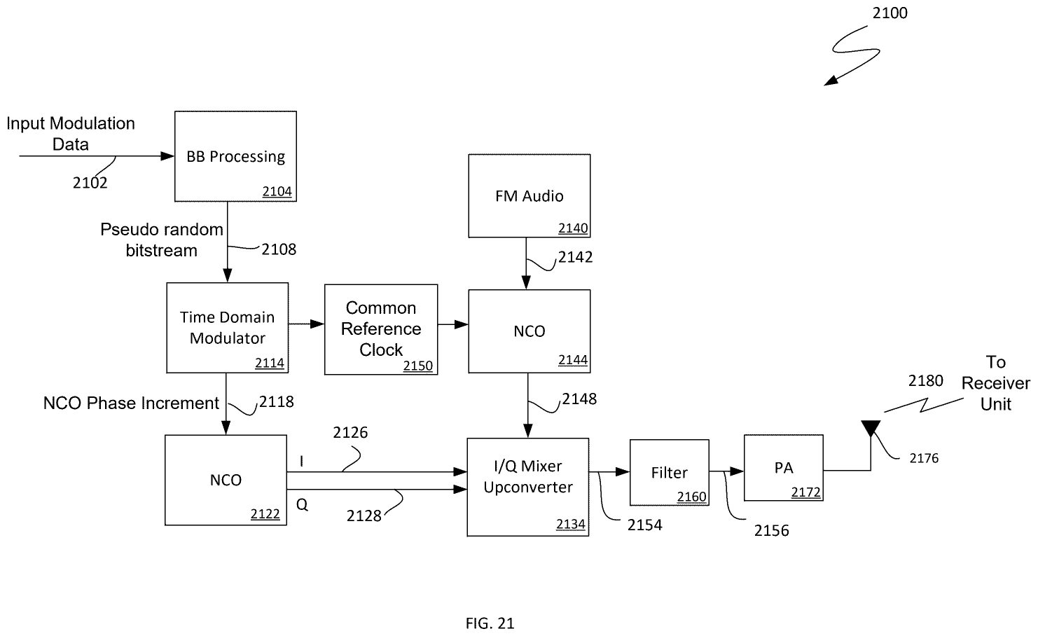

FIG. 21 is a block diagram representative of a transmitter 2100 configured to transmit auxiliary message waveforms with a frequency modulated communication signal in accordance with an embodiment. As shown in FIG. 21, input digital data 2102 is provided to a baseband processing unit 2104. In one embodiment the baseband processing unit 2104 performs standard framing, error correction and scrambling such that the bit stream 2108 produced by the baseband processing unit 2104 exhibits pseudorandom properties. The bit stream 2108 is provided to a time domain modulator 2114 configured to produce waveform data 2118 defining a zero-crossing modulated waveform of the type described herein. In one embodiment the zero-crossing modulated waveform data 2118 corresponds to phase increment values that are provided to a numerically controlled oscillator (NCO) 2122 configured to produce I zero-crossing waveform data 2126 and Q zero crossing waveform data 2128. The I zero-crossing waveform data 2126 and the Q zero-crossing waveform data 2028 define a complex zero-crossing modulated waveform of a desired frequency (e.g., 2 MHz). In one embodiment each period of the complex zero-crossing modulated waveform defined by the I zero-crossing waveform data 2126 and Q zero crossing waveform data 2128 is substantially identical to a sine wave from 0 to 90 degrees and from 270 to 360 degrees. Between 90 and 270 degrees the phase of the zero-crossing modulated waveform deviates from a purely sinusoidal phase in order to encode 1 and 0 values in the manner described herein. The I zero-crossing waveform data 2126 and Q zero crossing waveform data 2128 is provided to an I/Q upconverter mixer 2134.

In other embodiments the time domain modulator 2114 may be configured to store or otherwise access data defining a zero-crossing modulated waveform corresponding to a logical “1” and data defining a zero-crossing modulated waveform corresponding to a logical “0”. In these embodiments a separatee NCO 2122 is unnecessary and the time domain modulator 2114 would itself output the I zero-crossing waveform data 2126 and Q zero crossing waveform data 2128.

As shown in FIG. 21, an FM audio modulator 2140 provides an FM audio modulation signal 2142 to an NCO 2144 in order to generate an FM signal 2148. The NCO 2144 may generate the FM signal 2148 at essentially any desired frequency within the capabilities of existing hardware and software platforms (e.g., 100 MHz, 200 MHz, 425 MHz, etc.). In the embodiment of FIG. 21 timing for the NCO 2144 and the time domain modulator 2114 is provided by the same reference clock 2150 so that no phase shift exists between the FM signal 2148 and the zero-crossing modulated waveform defined by the I zero-crossing waveform data 2126 and Q zero crossing waveform data 2128. That is, the reference clock 2150 functions to lock the NCO 2144 and the time domain modulator 2114 in both frequency and phase. The data stream defining the FM signal 2148 is provided to the I/Q upconverter mixer 2134.

The frequency of the FM audio modulation signal 2142 should be substantially different from the frequency of the zero-crossing modulated waveform (defined by the I zero-crossing waveform data 2126 and Q zero crossing waveform data 2128) in order to ensure that there is no material interference between the FM signal and the zero-crossing modulated waveform generated by the transmitter 2100. For example, in one embodiment the frequency of the FM audio modulation signal 2142 is in the range of tens of kHz (e.g., 15 kHz) while the frequency of the zero-crossing modulated waveform is greater than, for example, 1 MHz.

The I/Q upconverter mixer 2134 effects a multiplication, which may be a complex multiplication, of the data stream defining the FM signal 2148 and the zero-crossing modulated waveform defined by the I zero-crossing waveform data 2126 and Q zero crossing waveform data 2128. For example, when the frequency of the zero-crossing modulated waveform is 2 MHz and the frequency of the FM signal 2148 is 423 MHz, the I/Q upconverter mixer 2134 produces a mixed signal 2154 including sum and difference signals at 425 MHz and 421 MHz, respectively. However, it will be appreciated that in other embodiments the frequency of the zero-crossing modulated waveform may be substantially different from 2 MHz (e.g., 1 MHz or 100 MHz) and the frequency of the FM signal 2148 may be substantially different from 423 MHz (e.g., 10 MHz or 800 MHz). In such embodiments the frequencies of the sum and difference signals included within the mixed signal 2154 produced by the I/Q mixer upconverter 2134 will also be substantially different from the exemplary frequencies identified herein. Continuing with the present example, a filter 2160 is configured to filter the difference signal at 423 MHz from the mixed signal 2154 and to pass, to a power amplifier 2172, a filtered signal 2156 containing the sum signal at 425 MHz. The filtered signal 2156 is then amplified by a power amplifier and 2172 and transmitted via antenna 2176 as a multi-component analog signal 2180; that is, an analog signal having an FM component mixed with a zero-crossing modulated signal component.

Once the reference clock 2150 has locked the NCO 2144 and the time domain modulator 2114 in both frequency and phase, the zero-crossing modulated waveform will appear as random phase noise to an FM receiver (to the extent the frequency of the FM audio modulation signal 2142 is materially different than the frequency of the zero-crossing modulated waveform). Similarly, under these conditions the FM signal 2148 will be seen as a random frequency drift within a receiver configured to receive the multi-component analog signal 2180 and decode the zero-crossing modulated waveform 2126, 2128. Although in the embodiment of FIG. 21 the multi-component analog signal is generated from an FM signal and a zero-crossing modulated waveform, in other embodiments a substantially similar approach may be used to generate a multi-component analog signal using an amplitude modulated (AM) signal and a zero-crossing modulated waveform.

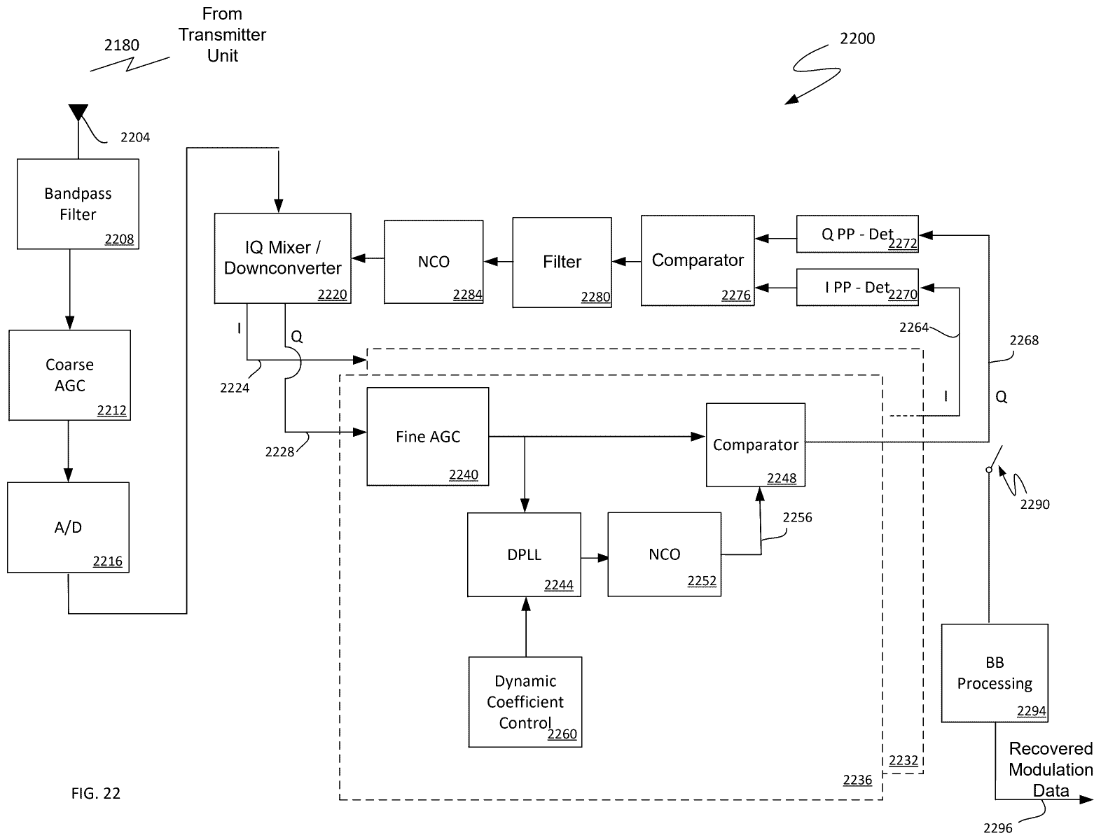

Attention is now directed to FIG. 22, which is a block diagram representative of a receiver 2200 configured to receive the multi-component analog signal 2180 and recover estimates of the input modulation data 2102 encoded by the zero-crossing modulated waveform 2126, 2128. As shown in FIG. 22, the receiver 2200 includes an antenna 2204 through which the multi-component analog signal 2180 is received and provided to a bandpass filter 2208. A coarse automatic gain control (AGC) circuit 2212 adjusts the gain of the filtered signal provided to an analog-to-digital (A/D) converter 2216. The digitized representation of the filtered version of the received multi-component analog signal 2180 is provided to an I/Q mixer downconverter 2220. As is discussed below, the I/Q mixer downconverter 2220 is configured to mix the digitized representation of the filtered version of the received multi-component analog signal 2180 with a recovered version of the carrier of the received multi-component analog signal 2180. The I/Q mixer downconverter 2220 produces a candidate zero-crossing modulated waveform signal having I and Q components 2224, 2228.

Referring to FIG. 22, the I component 2224 of the candidate zero-crossing modulated waveform signal is processed by an I component processing module 2232 and the Q component 2228 of the candidate zero-crossing modulated waveform signal is processed by a Q component processing module 2236. Except as otherwise indicated herein, the I component processing module 2232 and the Q component processing module 2236 are substantially similar or identical. As a consequence, only the details of the Q component processing module 2236 are described herein and the corresponding details of the I component processing module 2232 have been omitted for purposes of clarity. During operation of the receiver 2200, the I component processing module 2232 and the Q component processing module 2236 function to ensure that I component and Q component reference carriers generated in the receiver 2200 are locked in frequency and phase with the zero-crossing modulated signal inherent within the received multi-component analog signal 2180.

The Q component 2228 of the candidate zero-crossing modulated waveform signal is provided to a fine AGC circuit 2240 of the Q component processing module 2236. As shown, the output produced by the fine AGC circuit 2240 is input to both a Q component digital phase-locked loop (DPLL) 2244 and a Q component comparator 2248. The Q component DPLL 2244 and a Q component NCO 2252 cooperatively generate the Q component reference carrier 2256 provided to the Q component comparator 2248. In one embodiment the generation of the Q component reference carrier 2256 leverages the pseudorandom nature of the bit stream 2108 (i.e., the equal number of logical 1s and 0s within the bit stream 2108). Because of this characteristic of the bit stream 2108, the DPLL 2244 will lock to the frequency of the carrier used to generate the zero-crossing modulated waveform 2126, 2128 (e.g., 2 MHz). Different coefficients 2260 may be utilized to configure the DPLL 2244 before and after it has locked to the frequency of the zero-crossing modulated waveform 2126, 2128. The output of the DPLL 2244 is applied to the Q component NCO 2252, which produces a sine wave corresponding to the Q component reference carrier 2256. During operation of the receiver 2200, the comparator 2248 generates Q component soft bits 2268 (or “Q soft bits”) corresponding to candidate Q bit values by comparing the output of the fine AGC circuit 2240 to the Q component reference carrier 2256.

As is known, in the context of digital signal processing “soft bits” refer to estimates or confidence values associated with each received bit, indicating the likelihood that a 1 or 0 was transmitted. These soft bit values typically range between-1 and 1, with higher positive values suggesting a higher probability of a 1 being sent, and lower negative values indicating a higher probability of a 0. Soft bits contain more information than “hard bits”, i.e., discrete 0 or 1 values, as they provide a measure of the reliability or certainty of the received bit value. In contrast, hard bits simply correspond to the binary decisions made by a receiver, without any additional information about the confidence or reliability of those decisions.

As shown, the I soft bits 2264 and Q soft bits 2268 are provided to corresponding I and Q peak-to-peak (PP) detectors 2270, 2272. Each PP detector 2270, 2272 provides an indication of the difference between the expected values of the I or Q soft bits provided to it. As a consequence, the output of each PP detector 2270, 2272 increases as the expected values of the I or Q soft bits provided to it trend toward 0 and 1 and decrease as the values of such I or Q soft bits move toward intermediate values (i.e., to values distal from peak 0 and 1 values).

The I and Q PP detectors 2270, 2272 are included within I and Q feedback loops which are configured to maximize the output of one of the PP detectors (e.g., the Q PP detector 2272) and minimize the output of the other PP detector (e.g., the I PP detector 2270). These I and Q feedback loops further include a comparator 2276, a filter 2280, an oscillator 2284, and the IQ mixer downconverter 2220. The I feedback loop includes the I component processing module 2232 and the Q feedback loop includes the Q component processing module 2236.

As shown, the comparator 2276 receives the outputs of the I and Q PP detectors 2270, 2272. The output of the comparator 2276 is passed through the filter 2280. In turn, the filter 2280 provides the filtered output of the comparator 2276 as a control signal to the oscillator 2284. In an exemplary digital or software defined radio implementations the oscillator 2284 may comprise a numerical controlled oscillator (NCO). In analog implementations the oscillator 2284 may comprise a voltage controlled oscillator (VCO). In one embodiment, the I and Q feedback loops cause the comparator 2276 to drive the output of the Q PP detector 2272 to a maximum, which eventually causes the NCO 2284 to lock to the phase and frequency of the carrier of the received multi-component analog signal 2180. Once phase lock has been established between the NCO 2284 and the Q component NCO 2252, the receiver 2200 will have become locked in frequency and phase to both the carrier of the received analog signal 2180 and to the carrier of the zero-crossing modulated waveform signal defined by the I and Q components 2224, 2228. In one embodiment the values of the Q soft bits 2268 produced by the Q component comparator 2248 once such phase lock has been achieved are deemed to be of sufficient quality to be provided 2290 as hard bits to a baseband processing module 2294. The baseband processing module 2294 performs operations essentially corresponding to the inverse of the operations performed by the baseband processing module 2104 in order to produce recovered data 2296 corresponding to an estimate of the input modulation data 2102 (FIG. 21).

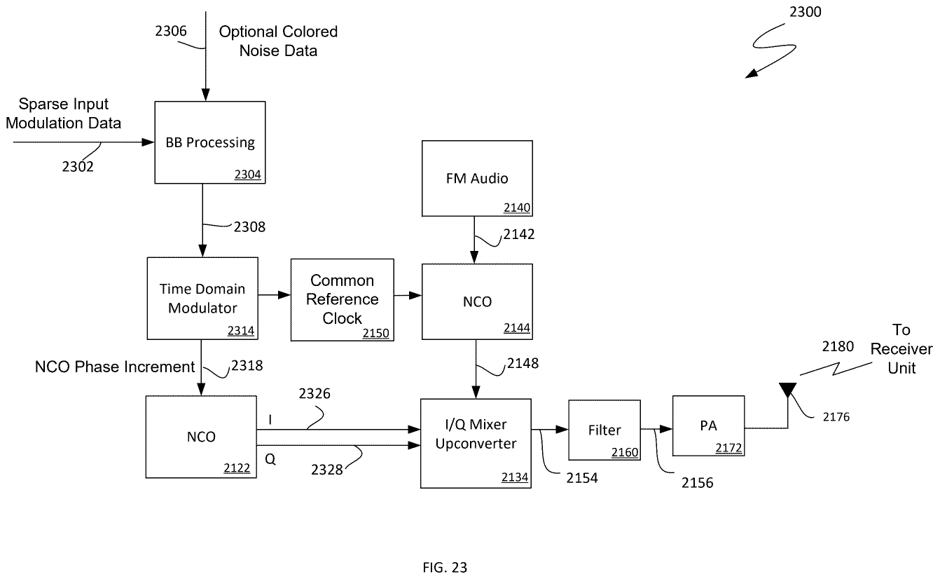

FIG. 23 is a block diagram representative of a transmitter 2300 configured to transmit auxiliary message waveforms, and optionally colored noise, with a frequency modulated communication signal in accordance with an embodiment. Except as otherwise indicated below, the transmitter 2300 is substantially identical to the transmitter 2100 of FIG. 21. The transmitter 2300 includes a baseband processing unit 2304 configured to produce a bit stream 2308 comprised of the input digital data 2302 and, optionally, colored noise data 2306.

In one embodiment the baseband processing unit 2304 is configured to structure the bit stream 2308 into frames such that a relatively high percentage of each frame consists of colored noise data 2306 and a relatively low percentage consists of input digital data 2302. For example, in one exemplary embodiment each frame corresponds to 1000 periods of a zero-crossing modulated waveform where 999 periods of each frame contain colored noise data and 1 period within the frame contains input digital data 2302. Thus, in this embodiment one bit of input digital data 2302 is included in every 1000 periods of the resultant zero-crossing modulated waveform. The colored noise data 2306, which occupies the remaining 999 of every 1000 periods of the zero-crossing modulated waveform, can be generated such that the zero-crossing modulated waveform appears essentially as phase noise of a desired type. For example, the colored noise data 2306 can be generated or otherwise defined to have the properties and characteristics of the phase noise associated with, for example, oscillators included within common electrical components, devices or systems. In this way even if the zero-crossing modulated waveform produced by the transmitter 2300 is observed, the observer may conclude that the zero-crossing modulated waveform is not a data-carrying modulated signal but instead corresponds to a source of phase noise (e.g., a local oscillator having phase noise of the type defined by the colored noise data 2306). Of course, in other embodiments more than a single bit of data may be included within each frame and the same period(s) within each frame need not be the ones designated to include a bit or bits of input digital data 2302. Many permutations of the mix of input digital data 2302 and colored noise data 2306 within each frame are possible provided that the receiver 2200 is made aware of the structure of each frame (i.e., which carrier periods include data and which include colored noise data 2306).

In another embodiment the time domain modulator 2314 produces the NCO phase increments 2318 such that the I zero-crossing waveform data 2326 and the Q zero-crossing waveform data 2328 modulate only a relatively small number of periods of the resulting zero-crossing modulated waveform with input digital data 2302. For example, the I zero-crossing waveform data 2326 and Q zero-crossing waveform data 2328 may be defined so that the NCO phase increments 2318 define a purely sinusoidal waveform for 99.9% of the periods of the resulting zero-crossing modulated waveform and define a 1 or a 0 data symbol in the remaining 0.1% of the carrier periods. Moreover, in the case where the periods of the zero-crossing modulated waveforms are organized into frames (e.g., 1000 periods per frame), the location within each frame of the one or more periods defining a zero-crossing modulated 1 or 0 data symbol may be varied from frame to frame provided this is known to the receiver 2200. To the extent this variation is pseudo-random or otherwise noise-like, an interested observer may be less likely to conclude that the zero-crossing modulated waveform produced by the transmitter 2300 is a data-carrying waveform.

The disclosure discussed herein provides and describes examples of some embodiments of the system for data communication with high spectral efficiency. The designs, figures, and descriptions are non-limiting examples of selected embodiments of the disclosure. For example, other embodiments of the disclosed device may or may not include the features described herein. Moreover, disclosed advantages and benefits may apply to only certain embodiments of the disclosure and should not be used to limit the various disclosures.

As used herein, coupled means directly or indirectly connected by a suitable means known to persons of ordinary skill in the art. Coupled items may include interposed features such as, for example, A is coupled to C via B. Unless otherwise stated, the type of coupling, whether it be mechanical, electrical, fluid, optical, radiation, or other is indicated by the context in which the term is used.

As used in this specification, a module can be, for example, any assembly and/or set of operatively-coupled electrical components associated with performing a specific function(s), and can include, for example, a memory, a processor, electrical traces, optical connectors, software (that is stored in memory and/or executing in hardware) and/or the like.

As used in this specification, the singular forms “a,” “an” and “the” include plural referents unless the context clearly dictates otherwise. Thus, for example, the term “an actuator” is intended to mean a single actuator or a combination of actuators.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations but can be implemented using a variety of alternative architectures and configurations. Additionally, although the invention is described above in terms of various embodiments and implementations, it should be understood that the various features and functionality described in one or more of the individual embodiments are not limited in their applicability to the particular embodiment with which they are described, but instead can be applied, alone or in some combination, to one or more of the other embodiments of the invention, whether or not such embodiments are described and whether or not such features are presented as being a part of a described embodiment. Thus, the breadth and scope of the present invention should not be limited by any of the above-described embodiments.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media in which the KCM may reside include, without limitation, one time programmable (OTP) memory, protected Random-Access Memory (RAM) and flash memory.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

While various embodiments have been described above, it should be understood that they have been presented by way of example only, and not limitation. Where methods described above indicate certain events occurring in certain order, the ordering of certain events may be modified. Additionally, certain of the events may be performed concurrently in a parallel process when possible, as well as performed sequentially as described above. Although various modules in the different devices are shown to be located in the processors of the device, they can also be located/stored in the memory of the device (e.g., software modules) and can be accessed and executed by the processors. Accordingly, the specification is intended to embrace all such modifications and variations of the disclosed embodiments that fall within the spirit and scope of the appended claims.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A method, comprising:
receiving input digital data;
generating, based upon the input digital data, zero-crossing modulated waveform data encoding the input digital data wherein the zero-crossing modulated waveform data represents an auxiliary zero-crossing modulated waveform having a plurality of periods wherein portions of the plurality of periods are perturbed in at least one of amplitude and phase relative to a sinusoid; and
mixing the zero-crossing modulated waveform data and modulation data representing a modulated signal so as to produce a multi-component signal.

2. The method of claim 1 wherein the multi-component signal is a digital multi-component signal, the method further including:
converting the digital multi-component signal into an encoded analog signal;
transmitting the encoded analog signal.

3. The method of claim 1 wherein the mixing includes multiplying the zero-crossing modulated waveform data and the modulation data.

4. The method of claim 1 wherein the mixing includes complex multiplying the zero-crossing modulated waveform data and the modulation data.

5. The method of claim 1 wherein the auxiliary zero-crossing modulated waveform comprises a shape-shifted sinusoidal waveform.

6. The method of claim 1 wherein the generating the zero-crossing modulated waveform data includes retrieving, from computer-readable memory, first zero-crossing modulated waveform segment data representing a first bit of the input digital data and second zero-crossing modulated waveform segment data representing a second bit of the input digital data.

7. The method of claim 1 further including generating the modulation data by modulating a numerically controlled oscillator with the modulation data.

8. The method of claim 1 wherein the generating zero-crossing modulated waveform data includes modulating a numerically controlled oscillator with baseband zero-crossing modulated waveform data.

9. The method of claim 1 wherein the modulation data includes frequency modulation (FM) data representing an FM signal.

10. The method of claim 1 wherein the modulation data includes amplitude modulation (AM) data representing an AM signal.

11. A method, comprising:
receiving a multi-component analog signal including a modulated signal and an auxiliary zero-crossing modulated signal encoding input digital data;
generating digital samples of the modulated signal;
mixing the digital samples of the modulated signal with a carrier signal for the modulated signal to create a downconverted signal; and
decoding the downconverted signal to obtain estimates of the input digital data.

12. The method of claim 11 further including recovering the carrier signal for the modulated signal from the digital samples of the modulated signal.

13. The method of claim 12 further including recovering a carrier of the auxiliary zero-crossing modulated signal based upon the downconverted signal.

14. The method of claim 13 wherein the decoding includes comparing a phase of the downconverted signal to a phase of the carrier of the auxiliary zero-crossing modulated signal.

15. An apparatus, comprising:
an input port receiving input digital data;
an auxiliary signal generator configured to generate, based upon the input digital data, zero-crossing modulated waveform data encoding the input digital data wherein the zero-crossing modulated waveform data represents an auxiliary zero-crossing modulated waveform having a plurality of periods wherein portions of the plurality of periods are perturbed in at least one of amplitude and phase relative to a sinusoid; and
a mixer connected to the auxiliary signal generator, the mixer being configured to mix the zero-crossing modulated waveform data and modulation data representing a modulated signal so as to produce a multi-component signal.

16. The apparatus of claim 15 wherein the multi-component signal is a digital multi-component signal, the apparatus further including:
a digital-to-analog converter configured to convert the digital multi-component signal into an encoded analog signal;
a transmitter configured to transmit the encoded analog signal.

17. The apparatus of claim 15 wherein the mixer is operative to multiply the zero-crossing modulated waveform data and the modulation data.

18. The apparatus of claim 15 wherein the mixer is operative to complex multiply the zero-crossing modulated waveform data and the modulation data.

19. The apparatus of claim 15 wherein the auxiliary zero-crossing modulated waveform comprises a shape-shifted sinusoidal waveform.
